(19) United States
(12) Patent Application Publication
(10) Pub. No.: US 2026/0260233 A1
(43) Pub. Date: Sep. 3, 2026

(54) COMPUTER-IMPLEMENTED SYSTEM AND METHOD FOR TREE-BASED DATA VERIFICATION, COMMUNICATION AND INTEGRITY SOLUTIONS

(71) Applicant: nChain Licensing AG, Zug (CH)

(72) Inventor: Craig Steven WRIGHT, London (GB)

(21) Appl. No.: 19/165,068

(22) PCT Filed: Mar. 11, 2024
(86) PCT No.: PCT/EP2024/056385

§ 371 Date: Sep. 12, 2025

(30) Foreign Application Priority Data
Mar. 17, 2023 (GB) 2303935.7

(51) Int. Cl. G06Q 20/38; G06Q 20/40

(52) U.S. Cl. CPC G06Q 20/3825; G06Q 20/3829; G06Q 20/401

(57) ABSTRACT

The invention resides in associating data with a blockchain transaction (Tx), wherein said data is represented in a tree structure, processing a path of the tree structure that includes the data; processing a digital signature of an author and/or approver of said data; and validating that at least one of: the data, the digital signature and the blockchain transaction (Tx) is a part of the tree structure. Similarly, the invention resides processing such data for recordal and subsequent validation. In one example, a web address is represented by a tree structure. The data associated with the data of at least a web page of the web address is represented in the tree structure, and at least one of the data, the processed data and/or the digital signature is associated with a blockchain transaction (Tx), which is represented in the tree structure. The data and the associated tree structure can be recorded and subsequently processed to validate the data. Through the association with the blockchain transaction, and processing the tree structure and a digital signature associated with the data e.g. a web page, or content thereof, the validity of the data can be determined, and the browser can selectively access only valid data.

### CROSS REFERENCE TO RELATED APPLICATIONS

This application is the U.S. National Stage of International Application No. PCT/EP2024/056385 filed on Mar. 11, 2024, which claims the benefit of United Kingdom Patent Application No. 2303935.7, filed on Mar. 17, 2023, the contents of which are all incorporated herein by reference in their entireties.

### FIELD

This disclosure relates generally to improved methods and systems for processing and/or management of data records and/or the format and/or content of such records. The disclosure is particularly suited, but not limited, to use in respect of transactions effected over or using a blockchain network, determining storage allocation, pre and/or post mining validation of blockchain transactions, SPV checks etc. Advantages include, but are not limited to, improvements in security and resilience, efficiency or reduction of speed and resource requirements, novel approaches to validation and the balancing of resources that have not been possible with prior art arrangements, thus leading to blockchain-implemented arrangements that have not been previously possible. The improved methods and systems are suited for tracking and/or validating items and/or their sub-components, at least one of: momentarily, over time and through changing applications. In particular, improved methods and systems are suited for validating that at least one of: data, a digital signature and/or a blockchain transaction is a part of a tree structure.

### BACKGROUND

While the Bitcoin protocol and network may be referred to herein for the purpose of providing illustrative context for implementation, the disclosure is not limited to use with the Bitcoin blockchain and alternative protocols and implementations fall within its scope.

A blockchain is a peer-to-peer, electronic ledger which is implemented as a computer-based decentralised, distributed system made up of blocks which in turn are made up of transactions. Each transaction is a data structure that encodes the transfer of control of a digital asset between participants in the blockchain system, and includes at least one input and at least one output. Each block contains a hash of the previous block so that blocks become chained together to create a permanent, unalterable record of all transactions which have been written to the blockchain since its inception.

In one or more example blockchain protocols, in order for a transaction (Tx) to be written to the blockchain, it must be validated. Network nodes (miners) perform work to ensure that each transaction is valid, with invalid transactions rejected from the network. Software clients installed on the nodes perform this validation work on an unspent transaction output (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be i) validated by the first node that receives the transaction—if the transaction is validated, the node relays it to the other nodes in the network i.e. it is propagated; ii) added to a new block built by a miner; and iii) mined, i.e. added to the public ledger of past transactions. Once the transaction is stored in the blockchain as a UTXO, a user can transfer control of the associated tokens to another address associated with an input in another transaction that is subsequently written to the blockchain. This is often done using a digital wallet which stores the public and private key pairs associated with the user's tokens. There are various forms of known digital wallet, including the SPV wallet (Simplified Payment Verification). SPV techniques allow users and merchant nodes to perform local verification based on only partial information that is relevant to a particular transfer. SPV is discussed in more detail below.

However, it is known that the volume of transactions will increase and improvements in the ability to rapidly determine the validity of an unspent transaction output (UTXO) are required. Current techniques for validation tasks can require significant resources and time due to the need to download and store blocks, maintain large UTXO pools and perform the necessary processing tasks for verification. Many users are either unable to meet such requirements or would prefer not to, possibly as they do not need to. Thus, there is a need for a faster, more efficient verification model which addresses at least these challenges (and others) without compromising security or requiring adaption of the existing protocol. Moreover, the means for verification must be scalable. Further still, known validation techniques are performed at a macro level. However, such an approach inhibits the validation of individual components and/or dynamic tracking of changes at a granular level in a set of data.

Such an improved solution has now been devised.

### SUMMARY

Embodiments of the disclosure provide improved blockchain-related methods, devices and systems. In accordance with one form of wording, such embodiments provide solutions for identifying and/or allocating the processing and/or storing of data associated with a blockchain transaction e.g. a UTXO that includes and/or enables validation.

In some embodiments, a tree structure is processed. The tree structure schematically represents the relationship between an item and at least one component thereof. The tree structure can enable the tracking and/or validating of the item and/or the at least one component. For example: a tree structure can be recorded at a point in time, to record the status of an item, component or inventory at an instant; the tree structure can change over time, which can reflect an update to the status and/or configuration of an item or the information associated with said item, and, of course a component of the item; and the application of an item or component can be tracked even when updated, wherein the item or one of its components is tracked in a first application using a first tree structure and in a second application using a second tree structure, thus tracking a history of the item or its component across different use scenarios. Overall, the tree structure can be used to track an item from creation to final use or disposal e.g. end-to end item tracking. Tracking the item using the tree structure enables the contents of the tree structure i.e. the item and/or components to be validated as part of the tree structure.

Item tracking can be achieved by associating the item and/or the at least one component of the item with a blockchain transaction (Tx), which is represented in the tree structure. The blockchain transaction can include data associated with the root of the tree structure, such that any data in the tree can be validated therefrom. For example, the tree structure can be a hash tree and the data associated with the root of the tree structure can comprise a hash of the root of the tree structure. At least one of the nodes and leaves of the tree structure can also be associated with a blockchain transaction.

In some embodiments, a third party can validate data prior to processing said data. This can include determining its provenance and/or authenticity. For example, validation can include associating data with a blockchain transaction (Tx), wherein said data is represented in a tree structure. A path of the tree structure that includes the data can be processed and/or a digital signature of an author and/or approver of said data can be processed. Processing said data can validate that at least one of: the data, the digital signature and the blockchain transaction (Tx) is a part of the tree structure. The digital signature is associated with the blockchain transaction. The digital signature can be combined with the data.

In one example, the techniques herein are used to configure and validate a web address and its components. In this way the content of a web page, e.g. HTML, attachments, can be validated on a machine before being processed, displayed or executed.

In another example, data is processed to produce processed data. Then said data and/or said processed data is associated with a digital signature of an author and/or approver of said data. The data and/or the processed data is then represented in a tree structure. Thereafter, at least one of the data, the processed data and/or the digital signature is associated with a blockchain transaction (Tx), which is represented in the tree structure. At least one of the data, processed data, the digital signature, the blockchain transaction (Tx) and the tree structure is recorded on a blockchain. The combination of the tree structure and digital signature, via the association with a blockchain transaction can provide an efficient scalable mechanism for validating and authenticating data.

Data associated with an item or component can be held in a record, said record being associated with a blockchain transaction. In some embodiments, item tracking can use techniques disclosed herein, such as determining that the record that comprises transaction data that proves at least a portion of a transaction (Tx) is included in the tree structure. The record can include a proof. For example, a proof can include a Merkle path that enables validation that a component is part of the tree structure. Further, a Merkle path can enable validation that the tree structure e.g. its root hash is part of a blockchain block (B). The record can comprise a data catalogue, said data catalogue is or comprises a set of the transaction data.

In other embodiments, a portion of data derived from a blockchain e.g. the transaction can be used to identify and/or allocate a processing and/or storage resource.

Item tracking and/or validation can include processing a record of the item and/or the at least one component of the item. Processing the tracked item as part of a tree structure enables validating that at least one of: the item, the at least one component of the item and the at least a portion of a blockchain transaction (Tx) is a part of the tree structure. Further an allocated resource can be used to process and/or store at least one of: the item, the at least one component of the item and the at least a portion of a blockchain transaction (Tx).

Validation of an item be improved using the tree structure and techniques herein, which can enable a structured and dynamic method and system for tracking and/or validation of the tree structure or part thereof. Moreover, validating that an item or component is part of a tree structure can be achieved securely and without disclosing confidential information associated with other items or components of the tree structure.

Using allocated resources can improve the scalability of the application of the tree structure by providing secure solutions for controlling, managing and/or enhancing the efficiency, resource requirements, speed and/or resilience of known approaches to processing of blockchain transactions.

The validity and/or provenance of an item, or component thereof, can be tracked across a plurality of tree structures, each tree structure representing the item and/or the at least one component of the item in different applications or use scenarios. Within a further tree structure e.g. a second tree structure, the item and/or the at least one component of the item can be associated with a further e.g. second blockchain transaction (Tx), which is represented in the further e.g. second tree structure.

During the process of validation, data can be securely exchanged and validated using the teaching of WO2017/145016, the teaching of which is incorporated herein by reference.

Embodiments of the disclosure provide improved blockchain-related methods, devices and systems. In accordance with one form of wording, such embodiments provide solutions for tracking an item, the at least one component of the item and the at least a portion of a blockchain transaction associated with the item and/or component. Said blockchain transaction can be stored on one or more of a plurality of resources, which can be distributed. Additionally or alternatively, the resources can be accessed to retrieve (i) confirmation of the validity of a transaction e.g. UTXO and/or (ii) data that enables the validity of the associated transaction to be determined.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain.

FIG. 2 schematically illustrates some examples of transactions which may be recorded in a blockchain.

FIG. 3 provides an illustration of a general Merkle tree structure as known in the art.

FIG. 4 illustrates how a Merkle root can be derived from a set of blockchain transactions, as known in the art.

FIG. 5 provides an example of how a Merkle tree can be divided into subsets (or “segments”) which may then be allocated to respective validation resources in accordance with an embodiment of the disclosure.

FIG. 6 illustrates an alternative example to FIG. 5 of how a Merkle tree may be divided into logical segments.

FIG. 7 illustrates, at system level, a distributed validation node in accordance with an illustrative embodiment of the disclosure.

FIG. 8 is a flow chart showing, at high level, the steps involved in an illustrative method of the disclosure.

FIG. 9 is a diagram showing the example system of FIG. 7 in more detail.

FIG. 10 is a schematic diagram of an example of the invention, including the identification and/or allocation of a resource that generates, stores or maintains a database of information associated with a transaction e.g. an unspent transaction output (UTXO) and/or a transaction (Tx) containing a UTXO.

FIGS. 11(a) to 11(d) are tables indicating examples of values derived from portions of data that are used to identify determine an allocated resource.

FIG. 12 is a schematic of a system including a node, intermediary switch and allocated resources, said resources having optional validators.

FIG. 13 is a schematic illustration of two transactions, which have a position within a Merkle Tree of a blockchain block, said transactions having an allocated resource, and the allocated resources hold corresponding records.

FIG. 14a is a schematic of an asymmetric tree structure in which a root node represents an item, and the nodes and leaves represent components of the item, while FIG. 14b represents two subsequent blockchain transactions associated with a node or leaf of FIG. 14(a).

FIG. 15 is a schematic of two tree structures, in which a blockchain transaction associated with a node or leaf e.g. of FIG. 14(a) is processed and/or stored in an allocated resource (1104).

FIG. 16 is a flow-chart representing a method of processing a tree structure.

FIG. 17 is a schematic of a tree structure representing at least a portion of a web-page's architecture, in which one of the nodes includes data and a digital signature.

FIG. 18 is a schematic of a user's computer that is configured to access data via the cloud and, optionally, an allocated resource.

FIG. 19 is a flow chart for establishing a tree structure including data having a digital signature.

FIG. 20 is a flow chart for validating data within a tree structure, said data having a digital signature.

### DETAILED DESCRIPTION

We now describe example embodiments of the disclosure for the purpose of illustration, without limitation, and with reference to the accompanying Figures.

A means for processing and/or storing information in relation to a transaction e.g. an unspent transaction output (UTXO) and/or a transaction (Tx) containing a UTXO can be implemented using different systems and methods, which can be configured and/or executed individually. Described below are examples of a ‘transaction database’ and ‘block validation’, each of which allocate tasks to resources e.g. distributed resources, said tasks including storing and/or validating one or more transactions.

Examples of allocating/identifying a resource in which information e.g. a record is allocated to a resource is described below in relation to a ‘UTXO database’. Also described below are examples of validating transactions, and the techniques/management of validation e.g. ‘block validation’.

Additionally, or alternatively to the examples of ‘allocation’ and/or ‘validation’, at least one example includes generating, storing, processing, accessing and/or maintaining a record of at least a portion of a transaction (Tx). The information stored in relation to a transaction i.e. the record, can be used to at least support the validation of the transaction. By way of example, the record can include transaction data for determining the at least a portion of a transaction is included in the Merkle path of a blockchain block.

Techniques taught herein are suited to tracking an item and at least one component of said item using a tree structure. The tree structure schematically representing the relationship between an item and at least one component thereof. The status of the item and/or its components can be associated with the tree structure through a blockchain transaction. The transaction can be used to determine the validation and/or provenance of an item and/or component from the point at which it was first tracked using a tree structure. Tracking can take place using one tree structure, or a plurality of tree structures. Each tree structure can represent an alternative relationship of the item and/or component with different items and/or different components. Tree structures can be independent, and a plurality of tree structures can be used to track an item and/or the at least one component of the item with a blockchain transaction (Tx) that migrates. The tree structure can be a Merkle tree, Binary tree, ancestor tree, asymmetric tree or otherwise unbalanced.

### Tree-Based Data Integrity Solution

Additionally, or alternatively to validating that an item e.g. a node is part of a tree structure, the integrity or authenticity of data associated with an item, such as a node of the tree structure, can be determined. Determination of the integrity e.g. through validation can be achieved at a granular level, with each node, or component thereof, being able to be validated. In contrast, while a certificate authority (CA) can provide a Secure Sockets Layer (SSL) that enables encrypted communication between a web browser and a web server, its global approval does not support a granular level of data integrity.

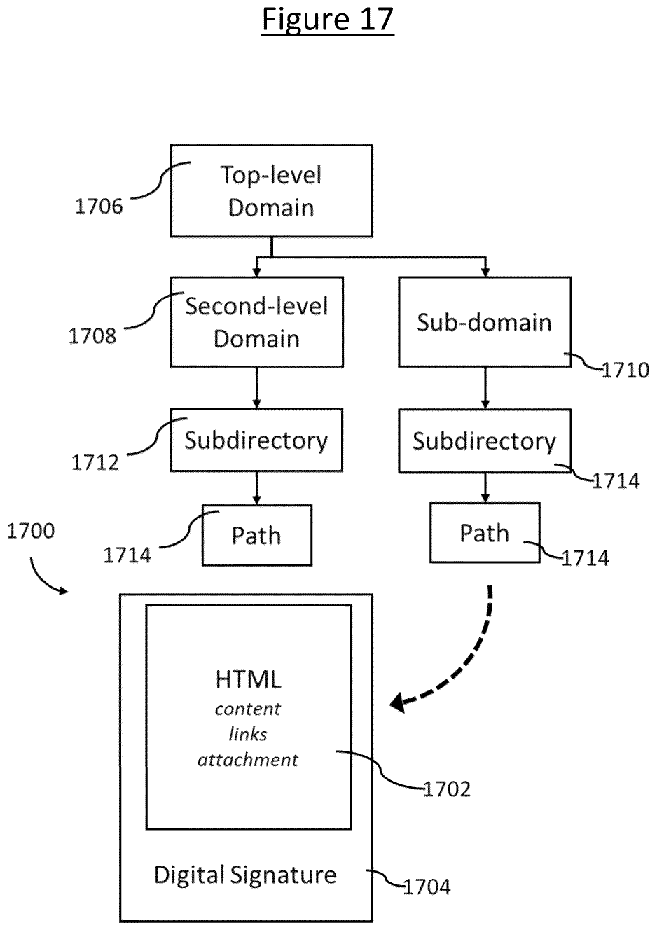

FIG. 17 is an example of data organised in a tree structure. The data in a tree structure can be associated with data in a blockchain transaction (Tx), or at least a portion thereof. The or each node in the tree structure can be authorised and/or approved by a digital signature. The signature serves as an attestation of the origin or authenticity of the data.

Preferably, each node can be digitally signed. By processing a path of the tree structure that includes the data, and the digital signature of an author and/or approver of said data, then at least one of: the data, the digital signature and the blockchain transaction (Tx) can be validated as part of the tree structure. This can be achieved by establishing a relationship between the nodes of the tree structure e.g. by establishing a hash tree. In this way, the validity and integrity of the data, or part thereof, of any node can be determined.

In the example of FIG. 17, the tree structure 1700 represents the anatomy of a web address, through which a web page 1702 and its content can be accessed. The web page can have an associated a digital signature 1704, which can be combined with the web page as a whole or to individual content. A plurality of digital signatures can be used and associated with the web page as a whole and individual content, such that each component of a web page e.g. the HTML content, link, files, attachments etc can have its own digital signature. The data, or part thereof, of the components e.g. web page can be signed by the digital signature 1704. Multiple digital signatures can be provided for the data e.g. one for each of the content, links and attachments.

The web address has data segregated into components including a top-level domain 1706, a second-level domain 1708, sub-domain 1710, two sub-directories 1712 and respective paths 1714. The web page 1702 can include data that comprises at least one of content, links and attachments. The content can comprise HTML content, files and/or executable files.

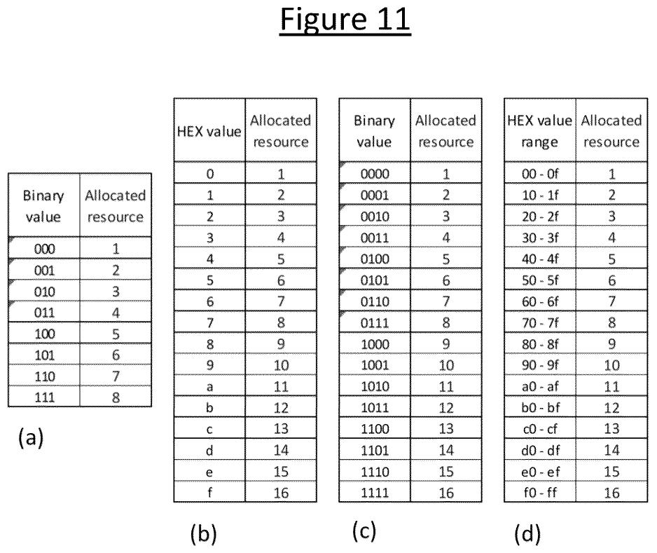

Each of the components, levels, domains, directories, sub-directories and paths can be represented in a tree-structure and have an associated blockchain transaction (Tx), or a portion thereof. As described in relation to FIGS. 11, 13, 14 and 15, at least one of: the data, the digital signature and the blockchain transaction (Tx) that is a part of the tree structure can be stored in an allocated resource 1104. Combinations of the data, the digital signature and the blockchain transaction (Tx) can be created for storage in an allocated resource 1104. The allocated resource can hold a record that, when processed, enables efficient validation of the data within a node e.g. HTML content, files and/or executable files etc.

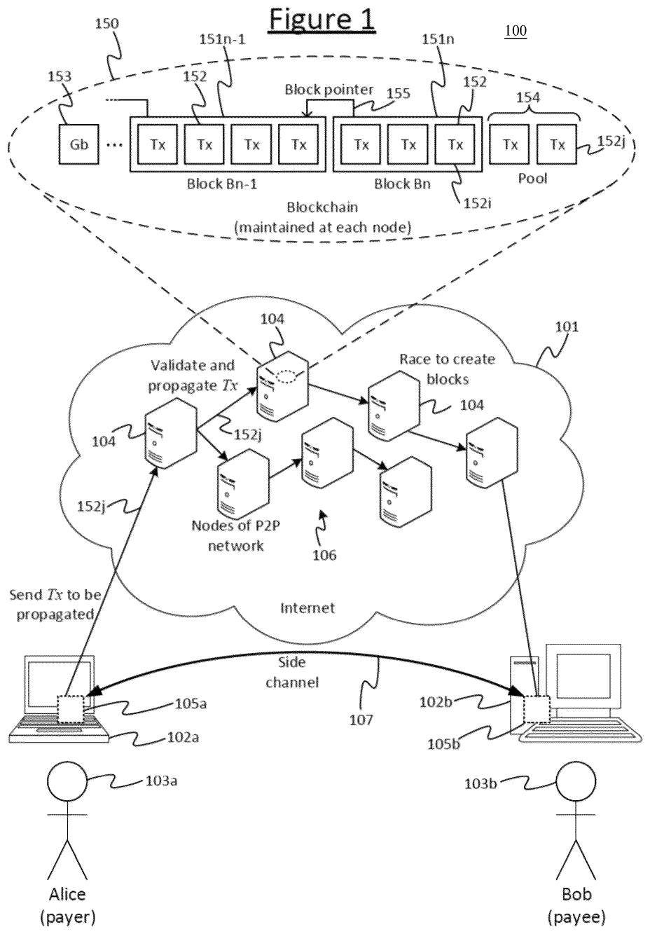

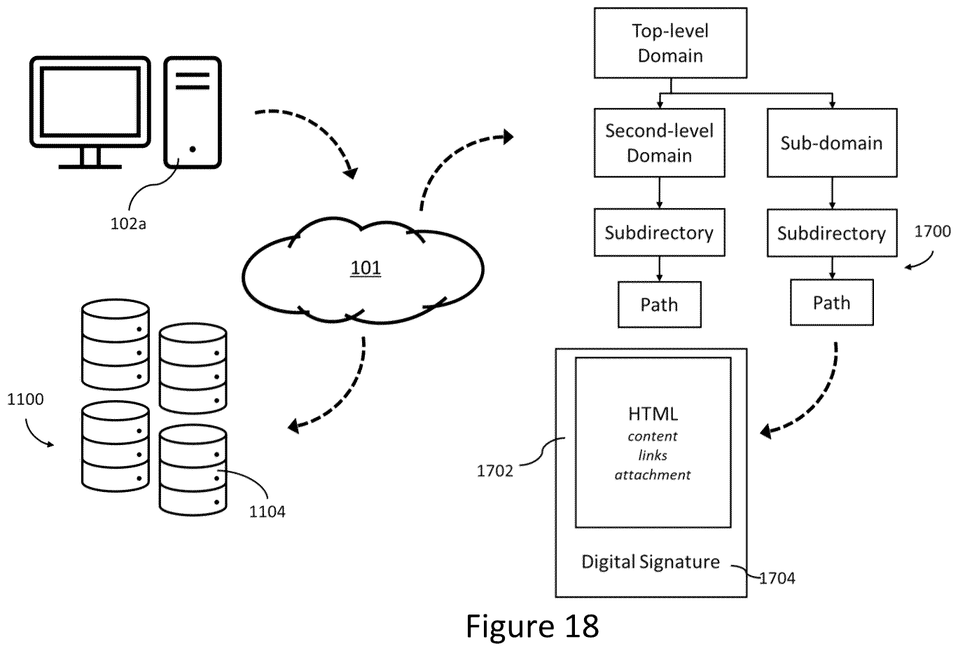

FIG. 18 represents an example of a system in which the methods herein can operate. A first party 103a and their respective computer equipment 102a can be configured to access a web page 1704 created by a second party 103b and their respective computer equipment 102b that has created a web address e.g. web domain 1700 for access via a network e.g. a packet-switched network 101, as described herein and shown in FIG. 1. Data can be processed on, or via, an allocated resource 1104 in a system 1100 of allocated resources, also described herein.

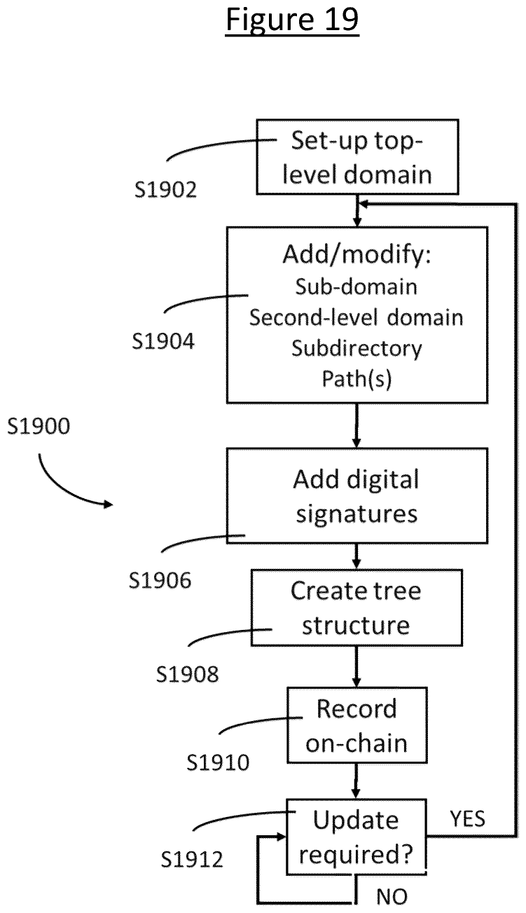

FIG. 19 is a process S1900 for processing data into a tree structure that can be validated. By way of non-limiting example, the process is suitable for representing a web address and its components in a tree structure, as shown in FIG. 17. At S1902 a top-level domain is established, which is comparable to the root of a tree structure. At S1904 components of the web address are added. At S1906 digital signatures 1704 are added to each of the components. The components and/or the digital signatures can be associated with respective blockchain transactions.

The components of the tree structure e.g. the web address, function as nodes when creating a tree structure S1908 representing the web address. Digital signatures can be associated e.g. added e.g. concatenated with the data. The data and the digital signatures can be hashed before and/or after association e.g. concatenation. With all the components of the web address associated in a tree structure a hash tree can be determined. A record S1910 of the tree structure can be recorded on a blockchain. Each node and the data associated with the node can be provided with validation data enabling validation of the component of the web address i.e. the node within the tree structure. Validation can use Simplified Payment Verification (SPV) techniques e.g. validating a relationship of a path in a tree structure between a node and another node, such as a root node.

The web address can be monitored for change S1912, and with each update, no matter how small, the addition and/or modification requires the original and/or a new digital signature of the author and/or authority in control to be processed with the component of the web address before an updated tree structure is established. Therefore, the data and/or contents of a component of a web address, e.g. each page, link, etc can be digitally signed. Signatures and updates can be applied incrementally. In this way, each iteration of the be page can be verified before it is accessed. Not only can this enable a machine to validate data and decide whether to execute or open content, but the source of any modification can be traced e.g. when the digital signature of a creator is used to digitally sign data. Through the tree structure and/or the digital signature the validity and authenticity of the content of the tree structure i.e. the data within the content of a node of the tree structure e.g. web page content, can be validation.

Overall, the process S1900 includes processing data for producing processed data, which is associated with a digital signature of an author and/or approver of said data. Examples herein relate to a web address and the content of web pages, which can be represented, although the teaching herein can be applied to the data in any tree structure having data or processed data. The data, the processed data and/or the digital signature can be associated with a blockchain transaction (Tx), which is represented in the tree structure. In this way, at least one of the data, processed data, the digital signature, the blockchain transaction (Tx) and the tree structure are recorded on a blockchain. At least one of the data, processed data, the digital signature, the blockchain transaction (Tx) and the tree structure can be encrypted e.g. hashed before being recorded on a blockchain. The tree structure can, therefore, be configured as a hash tree.

Updates to the data can produce updated processed data, which can occur when a tree structure e.g. a web page is updated. An update to one node in a tree structure has a ripple effect because of the relationship with at least one parent node, and at least the root node is changed. In effect, a second tree structure is created. Each amendment to a node of a tree structure can be tracked and validated e.g. using the digital signature applied to the node e.g. web page. The root, at least, of each version of the tree structure e.g. a hash of the root, can be recorded on-chain enabling each version of the tree structure, and the nodes therein, to be validated. Therefore, the processed data can be stored in a node of the tree structure or the second tree structure. Each node of the tree structure or the second tree structure can comprises at least one of data, processed data and/or the digital signature with a blockchain transaction (Tx), which is represented in the tree structure.

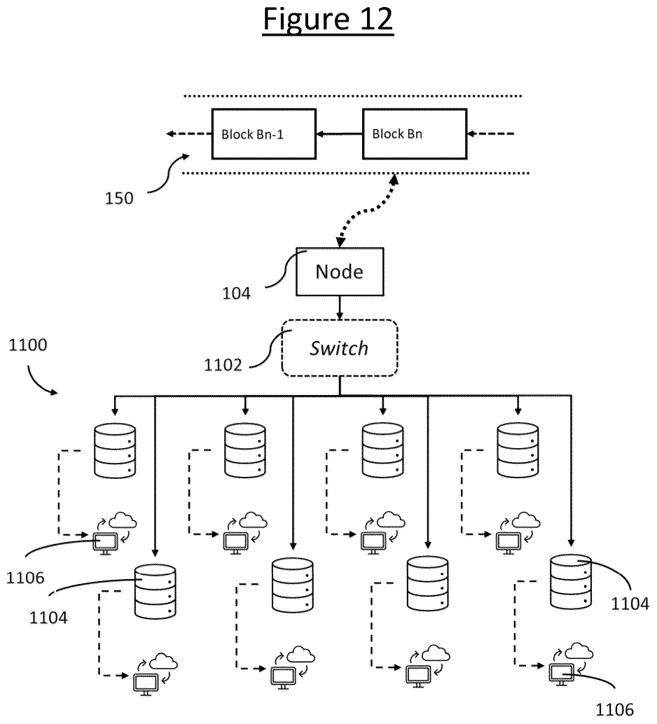

Additionally or alternatively to the tree structure e.g. web page of a web address being stored on-chain S1910, the data or a record of the data can be stored on a private server and/or an allocated resource 1104 that is part of the system 1100 of FIG. 12. Records of the data for validating and/or authenticating can, therefore, be held with the data or content and/or stored in a supporting resource 1104.

The process in S1900 enables data within a tree structure to be configured for validation e.g. a web page of a web address to be validated. In one example scenario, a machine 102a operates to access the content of a web page, which is a node in a tree structure. Before opening the web-page, the machine seeks to validate and/or authenticate the content of the web page e.g. the data of the web page. The machine will not open the web page or otherwise access its data content unless valid and/or authentic.

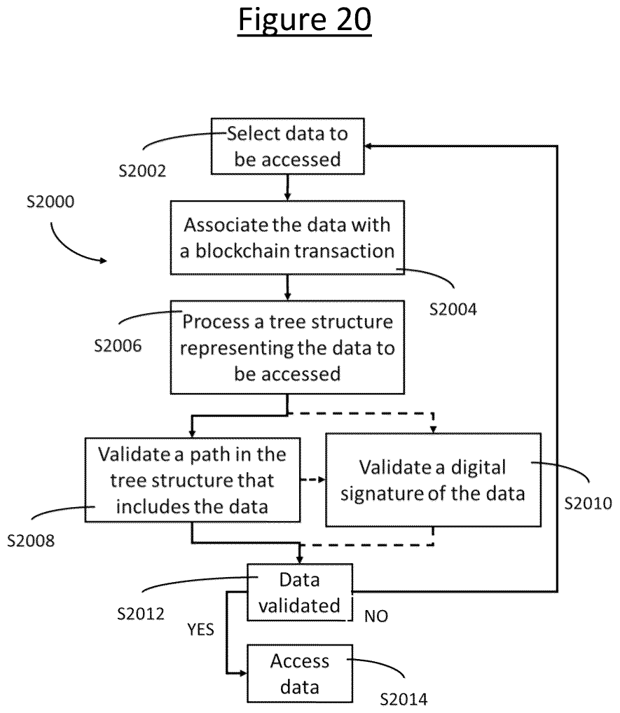

One example of a process S2000 for validating and/or authenticating data in a tree structure e.g. content of a web page via web address is shown in FIG. 20. In such an example, the machine 102a can select S2002 a web page 1700 to be accessed via the internet 101. The data to be access can then be associated S2004 with a blockchain transaction, which enables on-chain verification of the data and its associated tree structure. Records holding such information required for validation can be held on-chain associated with the blockchain transaction. Additionally or alternatively, records holding information required for validation can be held in an allocated resource 1104, which can provide efficient access to the required information for validation.

Once the data has been associated S2004 with a blockchain transaction the tree structure 1700 representing the data to be access is processed S2006. In one example, the tree structure is a hash tree, and the web page is a node of said hash tree and can be verified as being part of the tree. Moreover, the digital signature associated with the data e.g. the web page and its content can be used to validate and/or authenticate the data. Therefore, a path in the tree structure that includes the data is validated S2008 and/or a digital signature associated with the data is validated S2010. Such information can be held on-chain and/or in an allocated resource 1104.

The process determines validation of the data S2012, and if validated and/or authenticated the machine 102a access the data S2014, otherwise access is prohibited because the data is invalid, and alternative data to be access is selected.

Overall, by way of example, the process S2000 can be implemented by a browser and only permit machine 102a access to a web page or part thereof if data is valid and authentic. This can be achieved by processing a path of the tree structure that includes the data, processing a digital signature of an author and/or approver of said data, and validating that at least one of: the data, the digital signature and the blockchain transaction (Tx) is a part of the tree structure.

The digital signature 1704 associated with the data e.g. web page content can be the public key of the creator and/or authenticator of the data. Additionally, or alternatively, a digital signature 1704 can be the public key of the blockchain transaction associated with at least one of the data, the processed data and/or the tree structure. The digital signature 1704 can be combined with the data e.g. concatenated prior to the data being integrated into the tree structure, thus becoming an inherent component when determining validity of the data. Validating can then comprise determining that the digital signature is also a part of the tree structure.

Any one of said data, said processed data, the digital signature and the blockchain transaction (Tx) can be used to identify and/or allocate the allocated resource 1104 in which validation data for the data to be validated and/or authenticated can be found. This data can be used to determine a key that comprises at least one of: an alphanumeric number; and a binary number, and said number is used to determine the allocated resource. This data, or hash thereof, can be parsed to determine the allocated resource.

A record associated with an item and/or the at least one component of the item can be managed by using a blockchain transaction, which can be part of a blockchain token. The record can include information about the item or component, and data about the tree structure associates the item and/or the at least one component of the item with a blockchain transaction.

In light of the teaching herein features of the examples can be combined.

### Tracking Using a Tree Structure

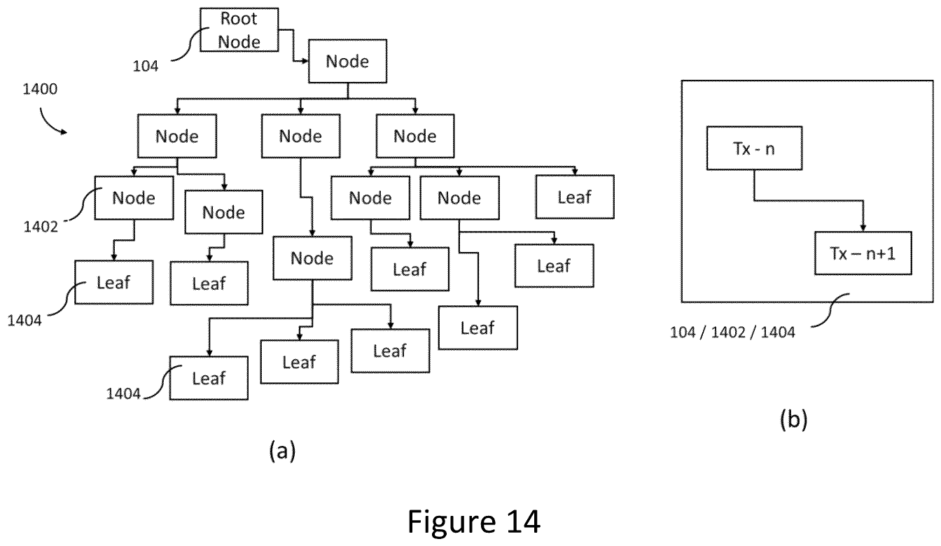

FIG. 14(a) shows a schematic of an asymmetric tree structure 1400, having a root node 104 and a plurality of nodes 1402 and leaves 1404. By way of example, the root node represents an item, while the nodes and leaves represent components of the item. The tree structure represents a relationship between the item and components. Each of the items and/or the at least one component of the item can be associated with a blockchain transaction. The item and/or the at least one component of the item can be tracked, managed or validated using an associated blockchain transaction, which can be associated with a blockchain token.

The tree structure can be used to determine the validation and/or provenance of an item and/or component. This can be achieved by the association between data within the nodes and leaves, and preferably by the blockchain transactions associated therewith.

The tree structure can be a hash tree e.g. a Merkle tree, which is a tree-like data structure used in cryptography for efficiently summarizing large amounts of data and proving the authenticity of the summarized data. Each leaf node 1404 represents a data block, and each non-leaf node i.e. a node 1402 is the hash of its child nodes. The root node 104 is a summary of all the data in the tree, and can be computed as the hash of all the leaf node hashes concatenated together.

Processing the tree structure 1400 enables the determination of the authenticity the data in the tree structure using, by way of example, the root hash and/or techniques using a proof and Simplified Payment Verification.

Therefore, by associating the item and/or the at least one component of the item with a blockchain transaction (Tx), which is represented in a tree structure, and processing the tree structure, or part thereof, that represents an item and/or at least one component of the item, then at least the validity of the item or component can be determined. Processing can comprise at least one of generating, storing, accessing and maintaining the tree structure. Updates to the data associated e.g. a record with an item or component, or the tree structure overall, can be updated and the tree structure and associated items tracked.

By creating a tree structure 1400 to track an item and/or its components, and by associating the item and/or the at least one component of the item with a blockchain transaction, then the validation and/or provenance of an item and/or component from the point at which it was first tracked using a tree structure can be determined.

The tree structure can change over time when at least one of the data, status and properties of the items and components of the nodes and leaves are updated. Using the association with a blockchain transaction enables tracking. FIG. 14(b) is a representation of one of a root node 104, node 1402 or leaf 1404 being updated, wherein a first associated blockchain transaction Txₙ is updated to become TXₙ₊₁. The transactions are linked and a record can immutably be determined from the blockchain. By way of example, data associated with a node or a leaf can be managed using a blockchain token. In one example, only the root node 104, or a hash thereof, is recorded on-chain, although each of the leaves and nodes can be recorded too.

A record of the item and/or component(s) can be associated with a blockchain transaction, which can function as a packet of data associated with the item or component. A record is an example of transaction data i.e. data held within a blockchain transaction e.g. in the script of a blockchain transaction. The record can hold data about the tree structure that which can be generated, stored, accessed and subsequently maintained. The record can hold data that can be used to (i) validate the item, component, or tree structure and/or (ii) determine the processing and storing of the data associated with the tree structure e.g. the data associated with the item or component.

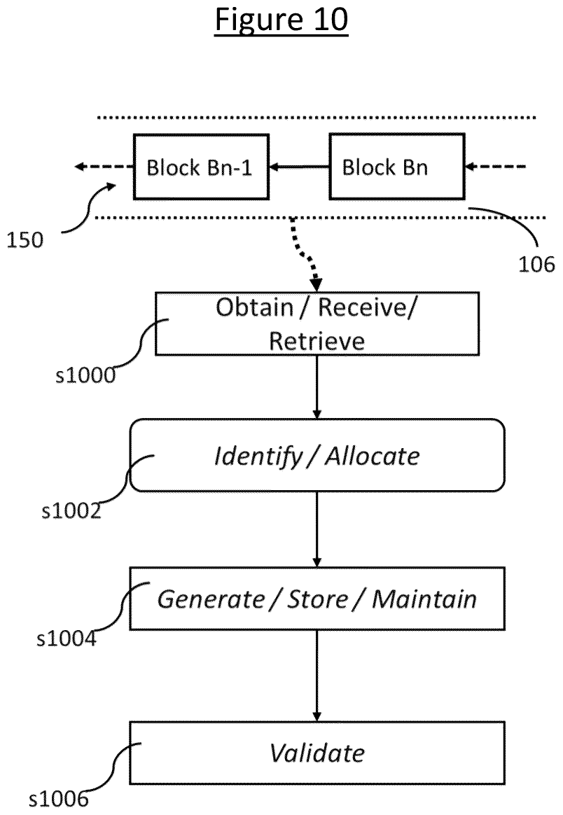

Once processed, the tree structure can be used to validate that at least one of: the item, the at least one component of the item and the at least a portion of a blockchain transaction (Tx) is a part of the tree structure. The blockchain transaction can be used to enable the processing e.g. validation or storage. Examples of storing and validation techniques are described in relation to FIGS. 10 to 13.

Tracking and/or validation can include computing the hash of each node in the tree structure, where the hash of a node is the hash of its children concatenated together. Hashes all the way up the tree structure can be checked to ensure that the tree structure has not been tampered. This can be achieved by computing the hash of each node in the tree, wherein each node in the tree structure is assigned a unique hash value, which is computed based on the data stored in the node and the hashes of its children. Then, parent node hashes can be compared with child node hashes, starting from the leaf nodes, and checking traverses the tree upwards to compare the hash value of each parent node with the hashes of its children. If the hashes match, it indicates that the data stored in the child nodes has not been tampered with. This process can be repeated for all nodes, such that if all hashes are consistent, the tree structure is determined to be authentic and has not been altered. Overall, the root hash can be used to determine the authenticity of the root node, which summarizes the tree structure, by comparing its hash value with a trusted hash value that was previously stored or distributed e.g. on a public blockchain, or a server running a private blockchain.

Additionally or alternatively, once processed, the tree structure can be used to process and/or store at least one of: the item, the at least one component of the item and the at least a portion of a blockchain transaction (Tx) in an allocated resource 1104. The tree structure itself can be stored in an allocated resource. While each leaf and associated data can be stored e.g. for validation, a hash of the root node 104 of the tree structure can additionally or alternatively be stored in a blockchain transaction e.g. on a blockchain ledger.

In one example, like FIG. 14, the tree structure, remains unchanged i.e. the items and components retain the same relationship. In this situation, the item and/or the components can be associated with at least one blockchain transaction to create a record for the tree structure. In practice, each of the items and components can be associated with their respective blockchain transactions. The tree structure can be a hash tree and the root hash and/or a hash of at least a portion of the data associated with an item or components, represented by nodes and leaves, can be recorded on a blockchain e.g. a public blockchain. Additionally or alternatively, the respective blockchain transactions associated with each of the items and components can be recorded in their original form, or hashed, on a blockchain e.g. a public blockchain. The or each of the blockchain transactions associated with the item and/or component can be updated when the data associated with the item is updated. In this way, data associated with the item or component can be tracked. Moreover, said data can be validated.

In another example, the tree structure can change over time, e.g. the arrangement of nodes and leaves can be updated, which can reflect an update to the status and/or configuration of an item or the information associated with said item or a component of the item. Similarly, the item and/or the components can be associated with at least one blockchain transaction to create a record for the tree structure e.g. each new arrangement is recorded. In practice, each of the items and components can be associated with their respective blockchain transactions. The tree structure can be a hash tree and the root hash and/or a hash of at least a portion of the data associated with an item or components, represented by nodes and leaves, can be recorded on a blockchain e.g. a public blockchain. With each change to the tree structure, the blockchain transactions associated with the item and/or component can be updated. Data associated with the item can be updated, and include an updated proof. In this way, data associated with the item or component can be tracked. Moreover, said data can be validated.

The data associated with the blockchain transaction representing the item or component e.g. the record, can include a proof that enables a third party to determine the validity of the data without knowing the full tree structure. The proof can be updated with each change made to the tree structure or when the tree structure changes. The proof can use Simplified Payment Verification techniques to determine the validity of an item or component e.g. using the blockchain transaction.

In yet another example, an item or component can be moved from one tree structure to another tree structure. Different tree structures can represent different entities e.g. physical entities, while the items or component in each structure is substantially the same, albeit with updated data associated with the item or component e.g. the association with a blockchain transaction is updated or a record of its use or application is modified.

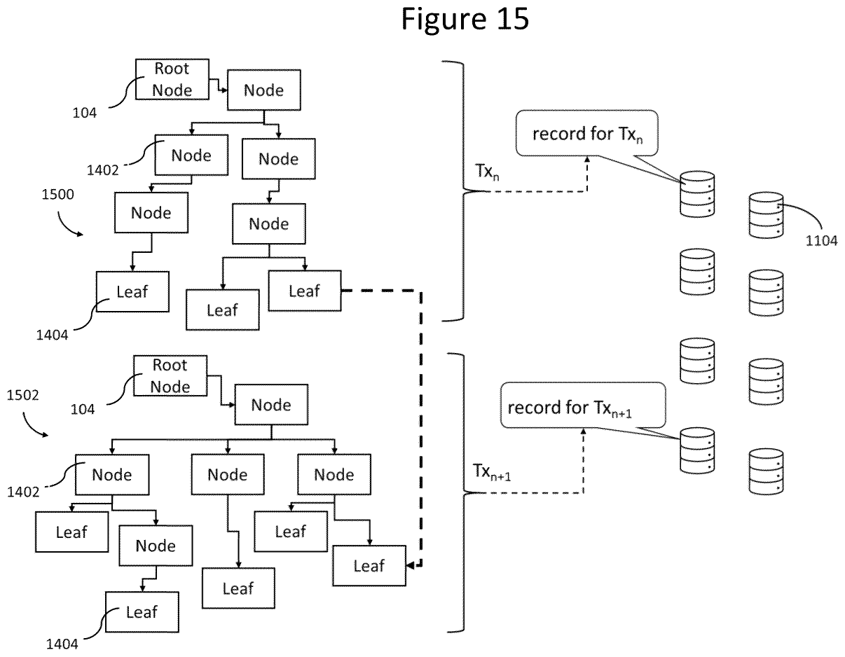

FIG. 15 illustrates a first tree structure 1500 and a second tree structure 1502, having nodes 1402 and leaves 1404. The first and second tree structure represent different respective entities. A hashed line connects two of the leaves, which represents a connection between the trees that arises when a component from a first entity represented by the first tree structure is transferred to a second entity represented by the second tree structure. The tree structures represent a point in time, thus the leaf is shown as part of the tree structure's history. At least the root node 104 e.g. a hash of the root node is associated with a blockchain transaction and recorded on a blockchain ledger. Preferably, each of the nodes and leaves are associated with a blockchain transaction and, similarly, recorded on the blockchain ledger. Through the history of the blockchain transaction(s) the validity of the or each component or item of the tree, or the tree structure itself, can be tracked and/or validated.

FIG. 15 further illustrates that each tree structure can be recorded in an allocated resource 1104, as per the techniques taught herein in relation to FIGS. 10 to 13. Additionally, or alternatively, data associated with each node 1402 and/or each leaf 1404 e.g. a record, can be stored in an allocated resource.

By way of example, x-ray data (component) can be produced from by a hospital department and held on their records within a structured database (item). The structured database can be represented as a tree structure, as taught herein, and used to track the database and items therein. The database and the x-ray data therein can form part of the tree structure, with at least one of the database and the x-ray data associated with a blockchain transaction, such that the tree structure can be processed to determine, at least, the validity of the tree structure. The x-ray data, however, can be transferred to another item e.g. a patients records and become part of another tree structure. Updating the blockchain transaction e.g. updating a blockchain token holding the data associated with the x-ray data enables the tree structure representing the patients records to be processed to determine the validity of the x-ray data. Validity can be determined from the transaction history and/or from a record within the blockchain transaction representing the x-ray that holds a proof, e.g. Merkle proof of the validity and/or provenance of the data. Validity can be determined for the x-ray being part of the hospital database, where the data originated, and also be validated as being part of the patients records. An item or component can be tracked, therefor, across applications e.g. from end-to-end. Validity can be determined without compromising privacy e.g. by disclosing full patient's records.

By way of another example, a first tree structure represents products manufactured from a production line, wherein the quality control checks, date and time of manufacture etc associated with the product e.g. an automobile airbag are held in a data e.g. a data packet such as a record of the component, which is part of the production records i.e. the item, which can be a database of production records. Post-production, the product can be transferred to a warehouse, and the associated blockchain transaction can be updated to show that the product (component) is now part of the warehouse inventory (item) having multiple components that is represented by a second tree structure. Therefore, the item and/or the at least one component of the item are further associated with the blockchain transaction (Tx), which is now represented in the second tree structure. The blockchain transaction is updated and, in effect, transferred from the first tree structure to the second tree structure. The item and/or the at least one component of the item are associated with the blockchain transaction (Tx), which is represented in both tree structures. A history of the product, therefore, can be held in the records associated with the blockchain transaction. An automobile's service history can be represented by a third tree structure, which can include MOT data (governmental test data), service data and details of replacement parts. An inventory of replacement parts e.g. headlamps, tyres and airbags can be represented in a tree structure as an ‘item’, with each replacement part listed as a ‘component’. Upon the new airbag being replaced on the vehicle the third tree structure is updated to include a new node or leaf representing the airbag. By way of example, the blockchain transaction holding the data packet for the airbag i.e. a record of the component, can be updated and included in a blockchain transaction associated with the third tree structure—like shown in FIG. 14(b). Through the blockchain transaction history and/or a record held in the blockchain transaction, a third party wishing to validate the replacement of the airbag can process the tree structure that represents the vehicle and confirm that the airbag was represented in the tree structure, and part of the vehicle. This can be achieved by the airbag being associated with the blockchain transaction (Tx), which is represented in the third tree structure. The record can additionally hold details of the airbag and/or an index of where to find details of the airbag in at least one of the first and second tree structures in which it was associated. The techniques herein, therefore, enable the tracking of items or components and the subsequent validation of those components. This can be achieved from creation to destruction, or from one end of a products life to the other end its life.

The data associated with the blockchain transaction representing the item or component e.g. the record, wherein said item or component has been part of another tree structure, can further include a proof e.g. a further proof or a second proof that enables a third party to determine the validity of the data without knowing the full tree structure or knowing the full second tree structure. The record can contain historical data of the item that enables its full provenance to be validated. The record can include a proof that the component e.g. airbag was part of a tree structure for an item e.g. a manufacturing facility, warehouse or vehicle. The proof can include a Merkle proof.

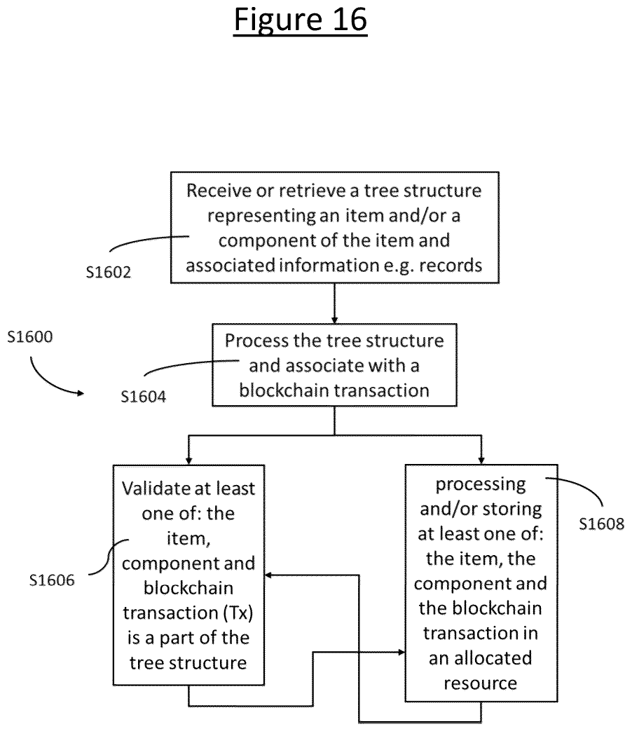

FIG. 16 illustrates steps S1600 for processing a tree structure 1400, 1500, 1502. The tree structure can represent an item and at least one subcomponent. The item and/or the at least one component of the item are associated with a blockchain transaction, which is represented in the tree structure. The relationship between the item and component(s) can be determined from a relationship between the data associated therewith e.g. the blockchain transactions. In one non-limiting example the tree structure can be a hash tree, and the items and components therein and/or their associated blockchain transaction, or part thereof, can be hashed. At least a hash derived from a hash of the root node of a tree structure can be stored in a blockchain e.g. a public blockchain. Preferably, a hash derived from each of the nodes and leaves can be stored e.g. on a blockchain. Using a proof e.g. a Merkle proof, an item or component can be validated as being part of said tree structure.

In S1602 a processor can receive or retrieve a tree structure representing an item and/or component thereof. Further, data associated with the tree structure is obtained, which can include information associated with the item and/or component thereof. The data can also be a hash of said information, or at least part of the information. For example, a processor can compute the hash of each node 1402 and leaf 1404 and be assigned a unique hash value, which is computed based on the data stored in the node and/or the hashes of its children.

In S1604, the processor processes the tree structure through the association with a blockchain transaction. Said transaction can hold data on the item or component in its script. The blockchain transaction can be part of a blockchain token.

In S1606, an item or component can be validated as part of the tree structure. This can follow, or precede, processing and/or storing S1608 the item and/or the at least one component of the item that are associated with a blockchain transaction (Tx), which are represented in the tree structure, in an allocated resource 1104. Data e.g. a record of an item or component can be validated before being stored, or vice-versa.

Validation techniques herein propose using a hash tree, wherein nodes and leaves of the tree are hashed, and a hash of the tree root is produced. Other techniques can be implemented in light of the teaching herein.

To validate that an item or component is part of a ‘hash’ tree structure a processor is provided with data e.g. a hash of an item or component, that indicates that it is part of a tree structure—for example, someone trying to prove that an airbag has been supplied or replaced on a vehicle can provide a tree structure representing the vehicle, or part of the structure that can prove the airbag is part of the tree structure. Part of the tree structure can be provided to maintain privacy. Alternatively, only hashed data associated with the other parts of the tree structure can be provided to maintain privacy. Validation can use Simplified Payment Verification techniques.

Using the tree structure, or part thereof, the processor can compute the hash of each node 1402 in the tree, where the hash of a node is the hash of its children, which includes the leaves 1404, and are concatenated together. The processor can determine that the hashes are consistent all the way up the tree to the root node to ensure that the tree is valid and unchanged. This can be achieved by the processor computing the hash of each node 1402 and leaf 1404 and comparing parent node hashes with child node hashes. Starting from the leaf nodes 1404 the processor can traverse the tree upwards and compare the hash value of each parent node with the hashes of its children. If the hashes match, it indicates that the data stored in the child nodes has not been tampered with. This can be repeated for all nodes until the root node is reached. If all hashes are consistent, it indicates that the entire tree is authentic and has not been altered. The root hash can also be validated to, which summarizes the entire tree structure.

Validating the tree structure, an item or component therein can be used to validate an item or component, by comparing data provided e.g. data associated with the replacement airbag in a vehicle, or its hash value, with a record of the tree structure that was previously stored or distributed.

Two or more tree structures can be used to validate an item or component, by comparing data provided e.g. data associated with the replacement airbag in a vehicle, or its hash value, with a record of a first and second tree structure that was previously stored or distributed e.g. as per FIG. 15. Having two or more tree structures can enhance the provenance of an item, which can be beneficial if an item or component has a history that extends across two or more applications and corresponding tree structures. The processor can, therefor, process the record of an item or component to validate that at least one of: the item, the at least one component of the item and the at least a portion of a blockchain transaction (Tx) is a part of the tree structure or another tree structure.

The data associated with the item, the at least one component of the item and the at least a portion of a blockchain transaction e.g. a record can include at least one of: a history of the or each tree structure from which the associated blockchain transaction originated; a history of the allocated resources in which the blockchain transaction was stored; and a proof that enables validation that the item, component or blockchain transaction is part of a tree structure e.g. the first and/or second tree structure.

Validating an item, component or blockchain transaction can be achieved by comparing against stored data e.g. manufacturing facility databases, warehouse inventory and vehicle service records, which can be stored in a blockchain. Data e.g. a record of a product can be used to determine that it is valid and originated from a particular tree structure. Determination can be achieved in such a way to restrict the validation only to the minimum necessary for that item or component, thus maintaining privacy. This can maintain the privacy of confidential information e.g. medical records.

As described above, with reference to Figured 13 and 15, a tree structure or part thereof, can be stored as data e.g. a record in an allocated resource. Any part of the data associated with the item, component or blockchain transaction can be used to identify and/or allocate the allocated resource. The part of the data can be a transaction e.g. an unspent transaction output (UTXO) and/or a transaction (Tx) containing a UTXO. FIG. 11 and the associated description describes one example of how the data can be used to determine an allocated resource.

The teaching herein is suited to handling secure and/or confidential data e.g. medical records because it has the ability to validate that an item or component of part of a tree structure without compromising the privacy of the other items or components. Moreover, the means for processing a tree structure is scalable by allocating the storage of at least one of the item, component of associated blockchain transaction in a pseudorandom way. Therefore, the allocation to resources can be load balanced, which can be implemented by using at least one of a portion of the data associated with the item, component or associated blockchain transaction to determine a key. The key can comprise at least one of: an alphanumeric number; and a binary number. At least one of a portion of the data associated with the item, component or associated blockchain transaction can be parsed to determine a key. For example, the data associated with a component can be hashed and/or parsed to determine a key and associated allocated resource 1104.

The data e.g. record associated with at least one of the item, component or associated blockchain transaction can comprise at least one of: a Merkle Tree of the block in which said transaction (Tx) is recorded; the Merkle root the block in which said transaction (Tx) is recorded; a Merkle path, which enables the determination of the value for the Merkle root for the block in which said transaction (Tx) is recorded, from a hash of said blockchain transaction (Tx); a Merkle proof; a block identifier (block_ID) associated with the blockchain block; a transaction identifier (TxID) associated with a transaction (Tx) in the plurality of blockchain transactions within the blockchain block; a function of the block identifier (block_ID) and the transaction identifier (TxID); and a concatenation of the block identifier (block_ID) and the transaction identifier (TxID).

The data e.g. record associated with at least one of the item, component or associated blockchain transaction can comprise at least one of: a proof that the associated blockchain transaction is part of the tree structure, by at least one of using a hash of the root of the tree structure and a path that enables the determination of the hash of the root for the tree structure in which said associated blockchain transaction is recorded, from a hash of said blockchain transaction; and a proof

### Records

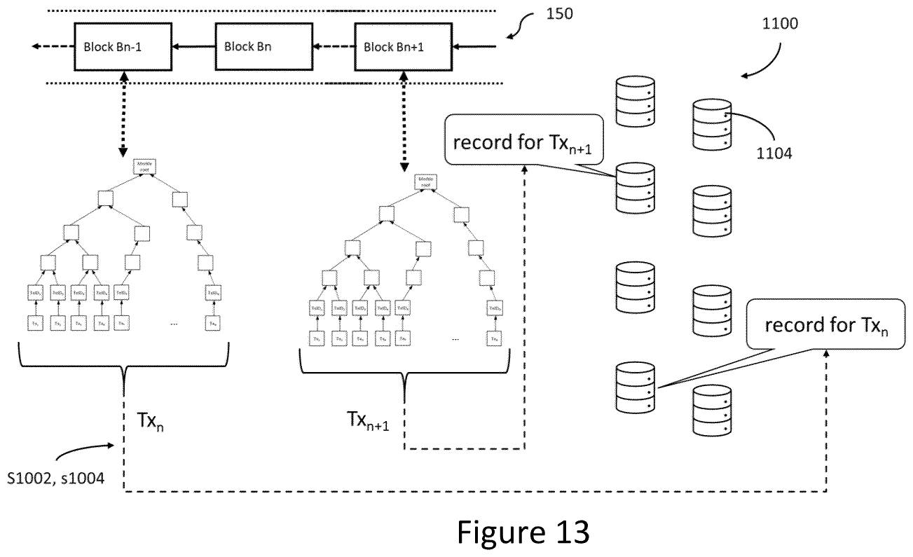

FIG. 13 illustrates two transactions derived from a blockchain 150. An example of a method herein at least one of generates, stores, processes, accesses and maintains a record of at least a portion of a transaction (Tx) in one of a plurality of resources 1104. The allocation and/or identification of the resource corresponding to each transaction is described below in relation to the UTXO database, which uses, by way of example, hash-table techniques for allocation. The resource 1104 can be one of a plurality of resources making up a database.

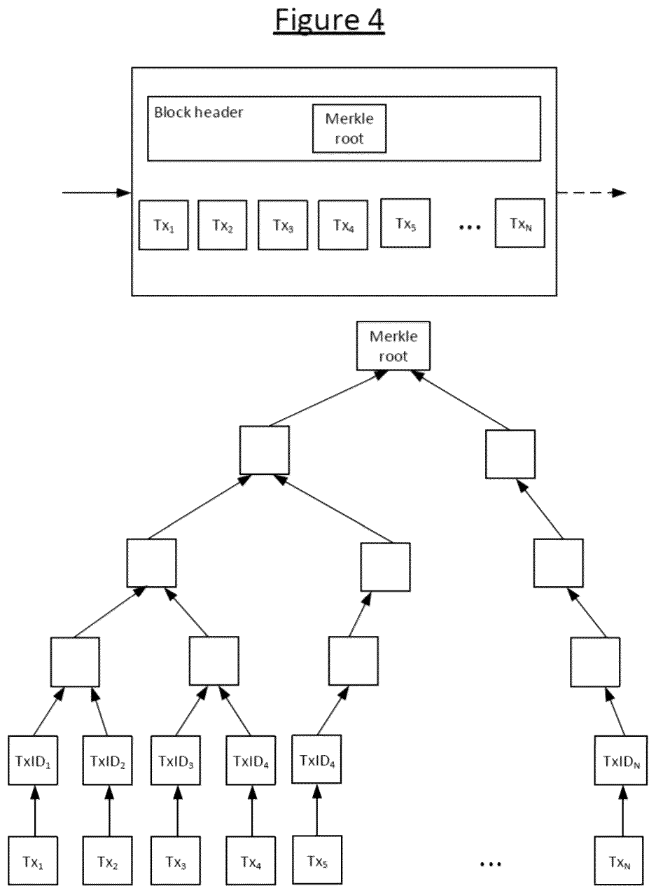

FIG. 13 illustrates two Merkle Trees, built using the set of transactions in a block, to determine a Merkle root that is included in the block header. Each of the transactions, Txₙ and Txₙ₊₁ are part of the respective Merkle Trees, as described below in relation to FIG. 4, at least.

A record comprises transaction data for determining the at least a portion of a transaction e.g. Txₙ or Txₙ₊₁ is included in the Merkle path of a blockchain block (B). Alone or in combination with the examples taught herein, the record holds data that enables efficient and cost effective reference and/or retrieval of information associated with a transaction. In particular, the information held in the record enables a third party wishing to verify a transaction to identify the allocated resource in which associated records are held, and retrieve transaction data for determining the at least a portion of the transaction is included in the Merkle path of a blockchain block (B). For example, the record holds a Merkle proof that the transaction is part of the Merkle tree that determined the Merkle root of the block in which the transaction is recorded.

The record can hold a set of data associated with the transaction. The records can, for example, be abbreviated and/or include concatenated data for efficient storage. The information in the record can be configured for reference. For example, the record can comprise a data catalogue. The data catalogue can be structured e.g. indexed, for selective identification and/or retrieval of information associated with the transaction. The data catalogue can hold a set of transaction data e.g. a Merkle proof that enables simplified payment verification (SPV).

The record, which can include a data catalogue, can be managed by the resource and/or a validator 1106. The record functions to hold information that can be stored/associated with a transaction e.g. a UTXO, for at least one of validation, status indication, holding signatures and transactional states. By way of example, a record can include at least a portion of script defining an “OP_PUSH_TX” to place conditions upon a transaction. The record, therefore, can provide a catalogue or library of information associated with a transaction.

The output of the transaction can be an unspent transaction output (UTXO) and/or a transaction (Tx) containing a UTXO of a blockchain block. The record is not limited to the output of a transaction, as suggested by the UTXO and OP_PUSH_TX records, and the at least a portion of a transaction (Tx) can include the output, input and/or any other parameters of the transaction.

The record can be stored in a database. The database can include a plurality of resources 1104 and/or validators 1106. A record can include a blockchain transaction (TX0) comprising at least one data item (D). Additionally or alternatively a record can include at least one further blockchain transaction (TX1) necessary for confirming that the blockchain transaction (TX1) is included in the Merkle path of a blockchain block (B).

The record, which can be a data catalogue, can be stored in a database or spread across a plurality of databases. The databases in themselves can be distributed across a plurality of resources 1104. The storage of records e.g., information and/or data as taught herein can be applied to and/or support the efficient allocation, referencing and accessing of records associated with nodes e.g., a Metanet node, and the associated Metanet protocol.

The following applications are incorporated herein by reference in their entirety:
PCT/IB2019/059793, which relates to indexing and structuring nodes
PCT/IB2019/059795, which supports mapping of categories to mnemonics e.g. cataloguing.
PCT/IB2019/059791, which supports searching a locating resources.
PCT/IB2019/059803, which supports wallets, blockchain search systems, block explorers etc. that enables a user to search for/access/view/write/retrieve a portion of data that's included in a Metanet node e.g. a transaction, and can identify a Metanet node based on its Metanet index.
PCT/IB2019/060226; PCT/IB2019/059807, which supports splitting data over multiple nodes.
PCT/IB2019/059808, which supports splitting records over multiple transaction inputs and multiple transaction outputs, in particular node attributes.
PCT/IB2019/059809, in which an atomic swap e.g. a conditional exchange is established between two or more parties.

Using the database and/or record and/or information can comprise generating, maintaining, providing, updating, storing, accessing or processing: i) the database; and/or ii) the data/record/information that is stored within, or in association with, the database. The database is stored in or across one or more resources, and the data, record, or information that is stored within the database is processed and/or stored in an allocated resource (1104).

Additionally or alternatively to the record comprising transaction data for determining the at least a portion of a transaction (Tx) is included in the Merkle path of a blockchain block (B), the record can hold a Merkle path from the transaction (TX0) to a root of a Merkle tree for the blockchain block (B). The Merkle path can comprise at least the minimum blockchain transactions necessary to establish or verify that the blockchain transaction (TX0) is included in the blockchain block (B). The records herein provide an efficient and effective means for validating a transaction. In combination with the allocation and identification of a resource in which the record is held and/or the validation techniques herein, an improved system for managing and/or using transaction data. Transactions can be derived from a blockchain block.

The blockchain transaction (TX0) can be used alone or in combination with the at least one further blockchain transaction (TX1) to verify that the blockchain transaction (TX0) is included in the Merkle path of the blockchain block (B). The data item (D), which can be part of the record or information stored in the allocated resource, can be at least one of: stored in association with a script in the transaction; and stored as metadata within the transaction. Overall, the record comprises validation data required to validate a transaction e.g., an unspent transaction output (UTXO) and/or a transaction (Tx) containing a UTXO.

The blockchain block can be stored on or in association with: a blockchain ledger; and/or an off-chain storage resource.

The record can comprise a history of at least one preceding transaction i.e. transaction data for at least one preceding transaction. The history can include a transaction of an unspent transaction output (UTXO) and/or a transaction (Tx) containing a UTXO. The at least one preceding transaction can be the previous transaction to the last transaction.

The record further can comprise a history of the allocated resources that processed and/or stored at least the previous transaction. The record can include a link to the allocated resource holding the previous transaction. The record can hold a history of a plurality of preceding transactions of the unspent transaction output (UTXO) and/or a transaction (Tx) containing a UTXO.

In this way, the history enables a third party using the record to retrieve the latest transaction and, if required, efficiently identify the previous transaction without performing a further look-up or search. The history can provide a back-catalogue or set of shortcuts to key records, data or information. The history can include at least one of: a set of transaction data for determining a Merkle proof of the plurality of preceding transactions; a link to the respective allocated resources that processed and/or stored the plurality of preceding transactions.

With reference to FIG. 13, a first transaction Txₙ is followed by a second transaction Txₙ₊₁. In the example, the first and second transaction have associated records stored in different allocated resources 1104, although they could both be stored at different addresses in the same allocated resource. The record of the second transaction can include, at least, a link to the address of the first transaction in an allocated resource. The record of the second transaction can include, at least in part, a record of the transaction data of the first transaction. The record of the second transaction can include a record of transaction data for a plurality of preceding transactions.

The record can comprise a flag and/or status indication of the transaction data e.g. the or each input of the unspent transaction output (UTXO) and/or a transaction (Tx) containing a UTXO. By way of example, the indications can be one of ‘seen’, ‘in-block’ and ‘double-spend’, thus providing an efficient reference to the status of transaction data.

The record can hold any number of transaction data information and/or supplementary data e.g. validation data. Using the record provides an alternative to searching, identifying and processing transaction data that is on-chain. The record can consolidate key data thus minimising the computational cost of using transactions and performing operations using a blockchain and blockchain blocks. The record can further comprises at least one of: a Merkle Tree of the block in which said transaction (Tx) is recorded; the Merkle root the block in which said transaction (Tx) is recorded; a Merkle path, which enables the determination of the value for the Merkle root for the block in which said transaction (Tx) is recorded, from a hash of said transaction (Tx); a Merkle proof; a block identifier (block_ID) associated with the blockchain block; a transaction identifier (TxID) associated with a transaction (Tx) in the plurality of blockchain transactions within the blockchain block; a function of the block identifier (block_ID) and the transaction identifier (TxID); a concatenation of the block identifier (block_ID) and the transaction identifier (TxID); a digital signature; an authentication code; and a signature message for determining a transactional state.

The allocated resource for processing and/or storage of the record can be identified and/or allocated using a portion of data derived from a blockchain to identify and/or allocate a resource, wherein said data from which the portion of data is derived comprises transaction data e.g. the unspent transaction output (UTXO) and/or the transaction (Tx) containing a UTXO.

The examples herein, and the associated systems, enable using a database comprising at least one record, the at least one record comprising: a blockchain transaction (TX0) comprising at least one data item (D); and at least one further blockchain transaction (TX1) necessary for confirming that the blockchain transaction (TX1) is included in the Merkle path of a blockchain block (B).

Using the database comprises generating, maintaining, providing, updating, storing, accessing or processing: the database; and/or data that is stored within, or in association with, the database. The record can further comprise a Merkle path from the transaction (TX0) to a root of a Merkle tree for the blockchain block (B). The Merkle path can comprise at least the minimum blockchain transactions necessary to establish or verify that the blockchain transaction (TX0) is included in the blockchain block (B).

The methods herein can use the blockchain transaction (TX0) and the at least one further blockchain transaction (TX1) to verify that the blockchain transaction (TX0) is included in the Merkle path of the blockchain block (B).

Said data item (D) can be stored in association with a script in the transaction; and/or can be stored as metadata within the transaction.

The transaction can further comprise at least one of: a transaction ID (TxID); a protocol flag; a discretionary public key (DPK); and a discretionary transaction ID (DTxID).

The above-mentioned records e.g. information and data associated with a transaction, derived from the transaction or in connection with the transaction can be stored in an allocated resource using the methods described below.

### UTXO Database

FIGS. 10 to 12 illustrate, respectively, stages of a method in which data is derived from a blockchain, tables used for allocation to a resources 1104 and an illustration of a system for implementing the method. Data is obtained from a peer-to-peer (P2P) network 106 and/or a blockchain 150. At s1000 data can be obtained or retrieved e.g. by requesting and obtaining one of more blocks from the blockchain 150. Retrieving can include downloading at least part of a blockchain block that comprises a plurality of blockchain transactions. Retrieving or otherwise obtaining data e.g. obtaining, copying or reading data from blockchain block is required when data is required to establish a stored and/or process historical e.g. already recorded in a block 151 transaction data related to an unspent transaction output (UTXO) and/or a transaction (Tx) containing a UTXO. UTXO currently in the mempool or future transactions and UTXO can be received via a connection to the network e.g. by implementing a node 104 that receives transactions broadcast on the network.

Overall, therefore, the system 1100 of FIG. 12 uses a portion of data derived from a blockchain, and determines a key and allocates a corresponding resource that will store information associated with said data e.g. information associated with an unspent transaction output (UTXO) and/or a transaction (Tx) containing a UTXO. To be clear, information associated with the data derived from the blockchain is to be stored in a resource for efficient and cost effective reference. The data can include an unspent transaction output (UTXO) and/or a transaction (Tx) containing a UTXO. A portion of that data is used to determine a key, which in turn determines an allocated resource that will store information about said data. The data from which the portion of data is derived comprises an unspent transaction output (UTXO) and/or a transaction (Tx) containing a UTXO. At s1002, a portion of said data is used to identify or allocate a corresponding resource 1104 e.g. an allocated resource. At s1004, the resource 1104 operates to at least one of generate, store and maintain a database of information, wherein said information includes data associated with the UTXO and/or transaction. The information can comprise an indication of the validity of the UTXO and/or enabling the validity to be determined e.g. using SPV techniques. The information about the data can include, by way of example, details of the block from which it was obtained e.g. the block ID, the Merkle path of the unspent transaction output (UTXO) and/or a transaction (Tx) containing a UTXO, the status of the validity of all UTXOs within a transaction.

The resource 1104 can operate to store information that can be used by others to validate UTXO and/or process the data to generate an indication e.g. a flag that indicates the validity. Additionally or alternatively, the resource 1104 can delegate the determination of the validity of a transaction or UTXO at s1006 to a validator 1106. Storing and/or processing at least a portion of the UTXO and/or the transaction (Tx) can be implemented: in the allocated resource e.g. the resource 1104 actively manages the information and maintains the database associated with each UTXO therein e.g. the resource can self-govern; and/or by the allocated resource e.g. the resource acts as a controller and functions as a system 1100 managing sub-resources to store and/or process the information; and/or in association with the allocated resource e.g. the resource 1104 operates as part of the system 1100, as shown in FIG. 12, in which, by way of non-limiting example, a node 104 provides transaction and UTXO information to a switch 1102 e.g. a router, that operates to determine which resource 1104 from amongst a plurality of resources is allocated the task of generating, holding and/or storing UTXO information in a database. Overall, a resource can implement and perform one of more of the operations in FIG. 10. FIG. 12 illustrates a system 1100 having components to perform the operations of FIG. 10 individually.

In one example, the task of holding information associated with a UTXO is allocated to one resource from a group of resources in the system 1100. FIG. 12, by way of example, illustrates 8 resources, each of which share the information from the UTXO between them. The system, however, can hold any number of resources and is scalable e.g. the system can have 16, 256 or 1024 resources. Each resource, therefore, is allocated a range of UTXO to process, store and/or maintain.

A portion of the data from an unspent transaction output (UTXO) and/or a transaction (Tx) containing a UTXO can be retrieved and/or received and parsed. Parsing determines which resource is allocated the task of storing information. The parsing can be performed by the resource 1104 or the switch 1102. At least one of the node 104, switch 1102 and resource 1104 can derive the portion of data from the blockchain. When parsing is performed by the node 104 or switch 1102, information is directed to the allocated resource. Identification and/or allocation to the processing and/or storage resource can be performed by the node and/or switch, which function as an intermediary. They are connected to a plurality of allocated resources, said node or switch operating as a manager of many resources 1104 that determines which resource looks after which UTXO/Tx. When parsing is performed by the resource 1104 it processes said data and/or stores information derived from said data, or stores data associated with said data, or takes no action if it is not responsible for the UTXO.

When the allocation of the resource 1104 is determined, e.g. it is determined where information associated with a UTXO/Tx will be held, the resource 1104 can perform the operation of s1004 and generate, store and/or maintain information associated with an unspent transaction output (UTXO) and/or a transaction (Tx) containing a UTXO. The resource 1104 can process data received to determine the validity of a UTXO/Tx e.g. s1006 or delegate that task to a validator 1106. The resource 1104 and/or the validator 1106 can validate, at least in part, the unspent transaction output (UTXO) and/or a transaction (Tx) containing a UTXO.

The data that is obtained from the peer-to-peer (P2P) network 106 and/or a blockchain 150. The data can be obtained by a node 104 and/or a switch 1102, which then allocates the data to a resource, or data can be obtained by the resource 1104 itself, which searches and parses data according to the range of UTXO/Tx it is allocated. The data obtained can includes at least one of: a UTXO identifier; a hash of the UTXO script; the transaction identification (TXID).

The data obtained relates to a UTXO or transaction having a UTXO functions to provide a key that identifies and/or allocates a resource where corresponding information is to be stored, maintained or generated. The key is determined either directly, by using a portion of the data e.g. the key determines the allocated resource, or indirectly, by processing e.g. hashing a portion of the data such that the resulting hash determines the allocated resource.

The key is used to determine which resource 1104 will hold corresponding information associated with the key. The resource, therefore, holds a data structure e.g. a database or hash table that implements an associate array. In other words, data associated with a UTXO and/or transaction is used to determine a key, and said key is used to determine a resource that holds information associated with the UTXO and/or transaction. Not only does the data and key enable a resource to be allocated, but the information stored can be retrieved by using the key to look-up and access said information.

At least one of the data, the key, and the resulting hash comprises at least one of: an alphanumeric number; and a binary number. The number is used to determine the allocated resource.

By way of example, the portion of data comprises an unspent transaction output (UTXO) and/or a transaction (Tx) containing a UTXO. An input to a transaction includes: a transaction ID, which references the transaction that contains the UTXO being spent; an output index e.g. Vout, which identifies which UTXO for that transaction is referenced; a scriptSig, which satisfies the conditions placed on the UTXO, for unlocking it; and a sequence number.

A potential recipient of the UTXO needs to validate the UTXO before the transaction spending said UTXO is compiled and broadcast. Known techniques for validation are slow, resource heavy and computationally expensive. By using a portion of data from the UTXO and/or the associated transaction information that validates or enables validation of the UTXO can be stored in a resource. Using a portion of data that is unique to the UTXO a key can be determined, which subsequently determines in which allocated resource the associated information can be stored, and subsequently be retrieved from.

Using the transaction identification (TxID) as a non-limiting example, the TxID is commonly referred to in its hexadecimal form, and can also be represented as a binary number. FIGS. 11(a) to (d) are tables indicating how a portion of the data can be used to determine an allocated resource. The portion of data e.g. TxID can be parsed directly or processed e.g. hashed. In FIG. 11(a), the TxID is parsed such that the first 3 digits of the TxID in binary form are selected as a key, and the resource allocated according to the binary value e.g. information associated with a TxID having a binary number with ‘101’ as the first three digits is allocated for storage/processing in allocated resource ‘6’. Using the first three digits binary enables one of eight resources to be determined, while FIG. 11(c) indicates how taking the first four digits from a TxID in binary form supports allocation between 16 resources e.g. information associated with a TxID beginning with binary number with ‘1011’ as the first four digits is allocated for storage/processing in allocated resource ‘12’. Alternatively, the hexadecimal value of the TxID can be used, as indicated in FIG. 11(b), in which a single hex value maps to a resource e.g. ‘c’ to ‘13’, and in FIG. 11(d), in which a range of hex values are allocated a resource e.g. information associated with a TxID beginning ‘76’ is allocated to resource ‘8’.

Alternatively, a portion of the data can be processed e.g. hashed, to produce a hexadecimal or binary number, so the portion of data and subsequent determination of a key to identify/allocate the resource 1104 is not limited to the TxID.

The portion of data selected from a transaction or its UTXO, or the processed value e.g. hashed value, is pseudorandom. The allocation to resources is load balanced i.e. the portion of data that is used to determine a key for allocating a resource is pseudorandom and distributes processing and/or storage between the plurality of resources. It follows that information associated with the transaction/UTXO is distributed across the plurality of resources. The balancing of allocation between the resources minimises the risk of some processing resources lying idle while others become overloaded and thus risk degradation of performance or even failure. The resilience, performance and/or efficiency of the system 1100 is improved.

The data, and portion of data, therefore, can be used to (i) determine the allocated resource, and thereafter (ii) provide a reference for identifying the resource and/or information associated with the data within the resource e.g. within a database.

It follows that the portion of data is derived from a blockchain, and determines a key and corresponding resource that will store information associated with said data i.e. information associated with an unspent transaction output (UTXO) and/or a transaction (Tx) containing a UTXO.

An actor seeking verification of the validity of a UTXO can use a portion of the UTXO and/or transaction holding said UTXO to identify a resource holding information that can be used to determine the validity of the UTXO and/or transaction. The information can include a flag or marker is associated with the and indicates whether the UTXO is locked or unlocked e.g. invalid or valid e.g. suitable for inclusion in a subsequent transaction. The information can additionally or alternatively include records of the UTXO and/or transaction holding said UTXO that enable an actor to efficiently and independently validate the UTXO.

Records can include, at least in part, at least one of: a Merkle Tree of the block in which said transaction (Tx) is recorded; the Merkle root the block in which said transaction (Tx) is recorded; a Merkle path, which enables the determination of the value for the Merkle root for the block in which said transaction (Tx) is recorded, from a hash of said transaction (Tx); a Merkle proof; a block identifier (block_ID) associated with the blockchain block; a transaction identifier (TxID) associated with a transaction (Tx) in the plurality; of blockchain transactions within the blockchain block; a function of the block identifier (block_ID) and the transaction identifier (TxID); and a concatenation of the block identifier (block_ID) and the transaction identifier (TxID).

The resource can include information and records required to determine the validity of a UTXO. Additionally or alternatively, the resource can itself, or via validation s1006 by a validator 1106, generate records that validate and/or support the validation of UTXO. The resource 1104 and/or the validator 1106 can at least one of: validate and/or verifying said UTXO; perform at least part of a Simplified Payment Verification (SPV) process for said UTXO; confirm whether a given blockchain transaction (Tx) is contained within the blockchain block; generate a hash of at least one of the blockchain transactions, using the hash to construct a Merkle path and/or checking whether the hash matches a transaction identifier (TxID) in a header of the blockchain block; and determine a Merkle proof for said UTXO.

By providing a means for identifying an allocated resource 1104 from a UTXO/transaction, and storing information required to validate said UTXO in said resource, an alternative method for validating a UTXO is provided that is efficient and scalable. No longer does a node need to hold a complete copy of the blockchain, and additional information is no longer required to support transactions e.g. SPV-based exchanges and wallets, the system 1100 and the resources 1104 therein provide rapid and scalable support.

Overall, the system 1100 comprises a resource 1104 that operates to provide a UTXO repository for generating, storing and/or maintaining information and/or records associated with a plurality of unspent transaction outputs (UTXOs), each associated with a transaction (Tx) in a plurality of blockchain transactions (TXs) of a blockchain block. The resource can record, search and/or process information and/or records by using a portion of data derived from a blockchain to identify and/or allocate said resource, wherein said data from which the portion of data is derived comprises an unspent transaction output (UTXO) and/or a transaction (Tx) containing a UTXO.

The system 1100 can include a node 104 and/or a switch 1102 for receiving and/or processing an unspent transaction output (UTXO) for inclusion in a transaction. The node and/or switch can support the resource and determine allocation to a resource amongst a plurality of resources. The allocated resource then holds validation data e.g. information and/or records for the UTXO.

After receiving a UTXO for inclusion in a transaction e.g. as part of payment or the transfer of a digital asset, validation information and/or records can be requested and/or obtained by an actor from the allocated resource.

Upon the actor accessing the information and/or records from the allocated resource that actor can at least one of: validate the UTXO and/or the transaction (Tx) containing said UTXO; and/or determine the validity of the UTXO and/or the transaction (Tx) containing said UTXO. Validation, by at least one of the resource 1104, validator 1106 and the actor can comprise: validating and/or verifying at least one blockchain transaction; and/or ii) performing a Simplified Payment Verification (SPV) process; and/or iii) confirming whether a given blockchain transaction (Tx) is contained within the blockchain block; and/or iii) generating a hash of at least one of the blockchain transactions, using the hash to construct a Merkle path and/or checking whether the hash matches a transaction identifier (TxID) in a header of the blockchain block.

Thereafter, following validation of the UTXO, said actor or a further actor can prepare and/or transmit a transaction (Tx) having said UTXO as an input.

A node 104 can be configured to at least one of generate, store and maintain a UTXO resource for recording, searching and/or processing a plurality of unspent transaction outputs (UTXOs), wherein said node processes a portion of data derived from a blockchain to identify and/or allocate a processing and/or storage resource. The data from which the portion of data is derived comprises an unspent transaction output (UTXO) and/or a transaction (Tx) containing a UTXO.

### Block Validation

Traditionally, nodes in a blockchain network maintain a global ledger of all transactions on the blockchain. The global ledger is a distributed ledger and each node may store a complete or partial copy of the global ledger. Transactions by a node affecting the global ledger are verified by other nodes so that the validity and integrity of the global ledger is maintained. The details of implementing and operating a blockchain network will be appreciated by those ordinarily skilled in the art.

Each transaction typically has one or more inputs and one or more outputs. Scripts embedded into the inputs and outputs specify how and by whom the outputs of the transactions can be accessed. The output of a transaction may be an address to which control of a value is transferred as a result of the transaction. That value is then associated with that output address as an unspent transaction output (UTXO). A subsequent transaction may then reference that address as an input in order to obtain control or ownership of that value.

As noted above, in accordance with one or more example blockchain networks and protocols, mining nodes compete in a race to create the next block in the blockchain. To assemble a block, a miner will build the block as a set of transactions from the pool of unconfirmed transactions (the “mempool”). It then attempts to complete a proof of work (PoW) puzzle with respect to the block it has assembled. If it manages to complete the PoW prior to receiving notice that any other miner has succeeded in generating its own block and completing its PoW, then the miner propagates its block by sending it to peer nodes on the network. Those nodes validate the block and then send it further on in the network to other nodes. If the miner receives notice that another block has been completed prior to finishing its own PoW, then the miner abandons its efforts and begins trying to build the next block.

Thus, fast propagation of blocks helps to avoid wasted effort (and associated energy) on behalf of miners and validating nodes. By providing a solution which enables faster validation and thus propagation of blocks, the present invention provides an enhanced network performance. It reduces the amount of computing time and effort required, and thus the amount of energy required by the network. It provides a network which is more efficient in terms of resources and time. It provides, ultimately, an improved (blockchain) network.

In some example implementations of blockchaineach node that receives a block first validates the block before sending it to other nodes. The time taken to validate a block slows propagation of the block through the network. Note that some implementations of blockchain, including evolutions of existing protocols, may provide for block validation by only a subset of nodes rather than each node in the network; however, block validation at most nodes is still likely to be a feature of any blockchain implementation to prevent invalid blocks from propagating through the network.

Validating a block involves confirming that the block meets prescribed criteria set by the applicable blockchain protocol. Example criteria applicable to one or more protocols may include functions such as CheckBlock and CheckBlockHeader. In addition to confirming that the block itself conforms to prescribed criteria, each transaction within the block may be assessed for compliance with transaction-level criteria. As an example, the transaction-level criteria applied in one or more example protocols may include the functions AcceptToMemoryPool, CheckTransaction and CheckInputs.

Specific examples of block-level criteria, based on one or more known protocols, may include:
The block data structure is syntactically valid.
The block header hash is less than the target difficulty (enforcing the proof of work).
The block timestamp is less than two hours in the future (allowing for time errors).
The block size is within acceptable limits.
The first transaction (and only the first) is a coinbase generation transaction.
All transactions within the block are valid.

Specific examples of transaction-level criteria, based on one or more known blockchain protocols, may include:
The transaction's syntax and data structure must be correct.
Neither the list of inputs nor of outputs are empty.
Each output value x, as well as the total of all outputs, must be within the range 0<x<21·10⁶.
None of the inputs have null hash.
nLockTime is less than or equal to INT_MAX.
The transaction size in bytes is greater than or equal to a minimum and less than a maximum.
The number of signature operations is less than the signature operation limit.
The unlocking script scriptSig can only push numbers on the stack, and the locking script scriptPubkey must match isStandard forms.
For each input, if the referenced output exists in any other transaction in the pool, the transaction must be rejected.
For each input, if the referenced output transaction is a coinbase output, it must have at least COINBASE_MATURITY (100) confirmations.
For each input, the referenced output must exist and cannot already be spent.
Using the referenced output transactions to get input values, check that each input value, as well as the sum, are in the allowed range of values x, i.e. 0<x<21·10⁶.
A matching transaction in the pool, or in a block in the main branch, must exist.
The sum of input values must be equal to or more than the sum of output values.
The transaction fee must be sufficient to gain entry to an empty block.
The unlocking scripts for each input must validate against the corresponding output locking scripts.

These example criteria are illustrative and should not be interpreted as sufficient or necessary to all embodiments as the prescribed criteria may differ in different protocols and may change over time for a given protocol if changes are made to the protocol. In general, transaction-level validation criteria are those prescribed characteristics which a transaction must have to be considered valid under the applicable blockchain protocol. Similarly, the block-level validation criteria are those prescribed characteristics which a block must have to be considered valid under the applicable blockchain protocol.

In accordance with the present application methods and devices are described that speed up block validation so as to facilitate faster propagation of blocks in the network.

In one aspect, the present application describes a node structured to validate blocks by performing at least transaction-level validation of individual transactions in parallel and/or in a distributed fashion. However, certain transaction-level criteria may not be evaluated in parallel. For example, the uniqueness of UTXOs may be evaluated on a serial basis. In such cases, the distributed validation node of the present disclosure may be structured or arranged to confirm the uniqueness of the referenced inputs (UTXOs) of the transactions prior to allocating the sets of transactions among a set of two or more parallel processors for validation of the remaining transaction-level criteria.

In particular, embodiments of the present disclosure provide improved verification and security solutions for processing related or associated data records that are stored in a tree structure. The tree can be a binary tree or a mesh structure. As known in the art, tree structures can be decomposed into smaller trees (which may be referred to herein as tree “segments”, “subsets” or “portions”), where each segment comprises a subset of the data records in the overall tree and has its own root. Advantageously, embodiments of the disclosure utilise this feature to provide methods and systems for distribution and parallelisation of processing of the related data records across multiple processing resources.

In our example embodiment, the plurality of data records comprises blockchain transactions which are related because they form nodes within a Merkle tree. The Merkle tree has a root which has been, or can be, included in a header of a block of the transactions in accordance with a blockchain protocol, such that the root provides a path that can be followed to every leaf (i.e. transaction ID (TxID)) within the tree. In our example, the blockchain protocol is, or is derived from, the Bitcoin protocol although other protocols fall within the scope of the disclosure.

In one example, processing of the plurality of transactions comprises validating at least a portion of a blockchain block that comprises the plurality of blockchain transactions and the root of the Merkle tree for the block. These examples are non-limiting and techniques disclosed herein may be utilized in respect of non-blockchain related data, and/or in respect of other processes besides validation. For example, embodiments may be used to stored, structure, search and/or maintain any type of data record that can be represented in a Merkle tree. Databases and other known storage resources may be utilized instead of, or as well as, the blockchain ledger.

In another example embodiment, processing of the plurality of transactions comprises downloading at least a portion of a blockchain block that comprises the plurality of blockchain transactions and the root of the Merkle tree for the block.

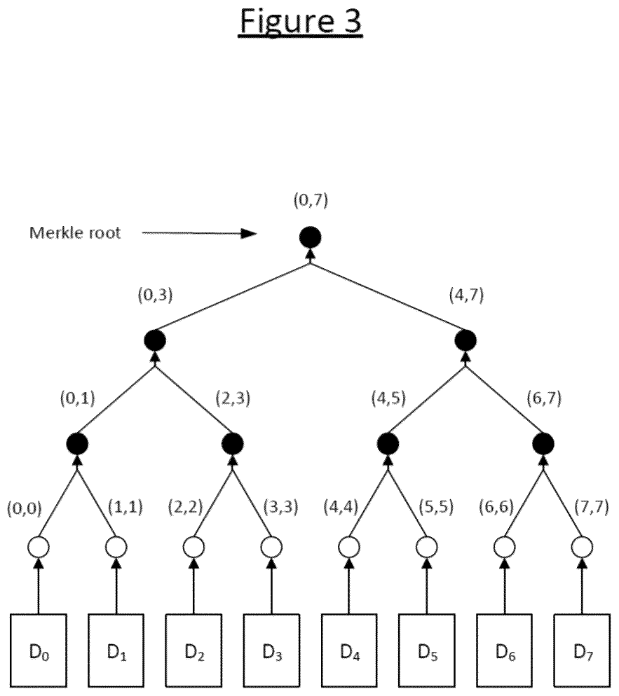

For completeness, and with reference to FIGS. 3 and 4, we now provide a discussion of Merkle trees and their use in representing blocks of blockchain transactions.

### Merkle Trees

With reference to FIG. 3, Merkle Trees are hierarchical data structures that enable secure verification of collections of data. In a Merkle tree, each node in the tree has been given an index pair (i,j) and is represented as N(i,j). The indices i,j are simply numerical labels that are related to a specific position in the tree.

A feature of the Merkle tree is that the construction of each of its nodes is governed by the following equations

$$N ( i , j ) = \{ \begin{matrix}H ( {D}_{i} ) & i = j \\ H ( N ( i , k ) ‖ N ( k + 1 , j ) ) & i \neq j\end{matrix} ,$$

where and H is a cryptographic hash function.

An example of a binary Merkle tree constructed according to these equations is shown in FIG. 3. As shown, we can see that the i=j case corresponds to a leaf node, which is simply the hash of the corresponding i^{th} packet of data Dᵢ. The i≠j case corresponds to an internal or parent node, which is generated by recursively hashing and concatenating child nodes until one parent (the Merkle root) is found.

For example, the node N(0,3) is constructed from the four data packets D₀, . . . , D₃ as

$$\begin{matrix}N ( 0 , 3 ) = H ( N ( 0 , 1 ) ‖ N ( 2 , 3 ) ) \\ = [ H ( N ( 0 , 0 ) ‖ N ( 1 , 1 ) ) ‖ H ( N ( 2 , 2 ) ‖ N ( 3 , 3 ) ) ] \\ = [ H ( H ( {D}_{0} ) ‖ H ( {D}_{1} ) ) ‖ H ( H ( {D}_{2} ) ‖ H ( {D}_{3} ) ) ] .\end{matrix}$$

The tree depth M is defined as the lowest level of nodes in the tree, and the depth m of a node is the level at which the node exists. For example, mᵣₒₒₜ=0 and m_{leaf}=M, where M=3 in FIG. 3.

For Merkle trees in some known blockchain implementations, the hash function is double SHA256, which is to apply the standard hash function SHA-256 twice: H(x)=SHA256(SHA256(x)).

The primary function of a Merkle tree is to verify that some data packet Dᵢ is a member of a list or set of N data packets [symbol] ∈{D₀, . . . , D_{N-1}}. The mechanism for verification is known as a Merkle proof and involves obtaining a set of hashes known as the Merkle path for a given data packet Dᵢ and Merkle root R. The Merkle proof for a data packet is simply the minimum list of hashes required to reconstruct the root R by way of repeated hashing and concatenation, often referred to as the ‘authentication proof’.

A proof of existence could be performed trivially if all packets D₀, . . . , D_{N-1} and their order are known to the prover. This does however require a much larger storage overhead than the Merkle proof, as well as requiring that the entire data set is available to the prover.

The comparison between using a Merkle proof and using the entire list is shown in the table below, where we have used a binary Merkle tree and assumed that the number of data blocks N is exactly equal to an integer power 2.

The following table shows the relationship between the number of leaf nodes in a Merkle tree and the number of hashes required for a Merkle proof (or Merkle proof).

| | | | | | Merkle tree |
|---|---|---|---|---|---|
| No. data packets | 32 | 256 | 1024 | 1048576 | N = 2^{M} |
| No. hashes required for | 5 | 8 | 10 | 20 | M = log₂ N |
| proof of existence | | | | | |

In this simplified scenario—where the number of data packets is equal to the number of leaf nodes—we find that the number of hash values required to compute a Merkle proof scales logarithmically. It is clearly far more efficient and practical to compute a Merkle proof involving log₂ N hashes than to store N data hashes and compute the explicit proof.

If, given a Merkle root R, we wish to prove that the data block D₀ belongs to the ordered list [symbol] ∈{D₀, . . . , D_{N-1}}represented by R we can perform a Merkle proof as follows
i. Obtain the Merkle root R from a trusted source.
ii. Obtain the Merkle proof F from a source. In this case, F is the set of hashes:

$$Γ = \{ N ( 1 , 1 ) , N ( 2 , 3 ) , N ( 4 , 7 ) \} .$$

iii. Compute a Merkle proof using D₁ and Γ as follows:
   a. Hash the data block to obtain:

$$N ( 0 , 0 ) = H ( {D}_{0} ) .$$

b. Concatenate with N(1,1) and hash to obtain:

$$N ( 0 , 1 ) = H ( N ( 0 , 0 ) ‖ N ( 1 , 1 ) ) .$$

c. Concatenate with N(2,3) and hash to obtain:

$$N ( 0 , 3 ) = H ( N ( 0 , 1 ) ‖ N ( 2 , 3 ) ) .$$

d. Concatenate with N(4,7) and hash to obtain the root:

$$N ( 0 , 7 ) = H ( N ( 0 , 3 ) ‖ N ( 4 , 7 ) ) ,$$

$${R}^{′} = N ( 0 , 7 ) .$$

e. Compare the calculated root R′ with the root R obtained in (i):
   1. If R′=R, the existence of D₀ in the tree and therefore the data set [symbol] is confirmed.
   2. If R′≠R, the proof has failed and D₀ is not confirmed to be a member of [symbol] .

This is an efficient mechanism for providing a proof of existence for some data as part of the data set represented by a Merkle tree and its root. For example, if the data D₀ corresponded to a blockchain transaction and the root R is publicly available as part of a block header then we can quickly prove that the transaction was included in that block.

### SPV

Simplified Payment Verification (SPV) takes advantage of these features of the Merkle tree, as first set out in section 8 of Satoshi Nakamoto's 2008 whitepaper “Bitcoin: A Peer-to-Peer Electronic Cash System”. In a SPV-based exchange of tokens between Alice and Bob, both parties use the same type of SPV wallet. The SPV wallet stores the user's private and public keys, unspent transactions and block headers which uniquely identify the blocks so they can be located on the blockchain. As explained, a block header comprises fields of data which provide a unique summary or fingerprint of the entire block's contents as well as a field that provides the Merkle root for that block. The Merkle root is generated by repeatedly hashing together pairs of transaction IDs (TxIDs) from the block until a single hash is finally arrived at. The Merkle root provides an efficient and secure mechanism for verifying that a transaction is part of a block because it allows users such as wallets and merchant nodes to locally verify a particular transaction without downloading the whole blockchain. This is advantageous for users who do not need or wish to run a full node but simply need to perform a localised check that a certain transaction is in a particular block e.g. parties such as merchants and customers who wish to perform a transfer between them. In summary, SPV enables such a user to search a Merkle tree having a given root to check (i.e. verify) whether a particular transaction is included in a particular blockchain block without them having to download and store the entire blockchain.

Therefore, SPV wallets provide at least the advantage that power and storage constrained devices such as phones and laptops are able to operate within the blockchain ecosystem because it only needs to confirm that a transaction has been verified (hence the name “simplified payment verification”) rather than performing a full check of the blockchain as per other forms of wallet. Since an SPV wallet only downloads block headers without including any of the transactions, this significantly reduces the storage space, energy and processing resources required for verification. SPV wallets are particularly suited for use with embodiments of the disclosure for reasons explained below, and we use the term “verification” herein to include SPV checks.

### Blocks of Transactions

FIG. 4 schematically illustrates an example of a blockchain block. Each block contains a block header and a set of transactions. The block header includes, amongst other things, a hash of the previous block header, i.e. a hash of the block header of the block upon which the current block is built. The block header also includes a Merkle root of a Merkle tree built using the set of transactions. Each transaction is first hashed (e.g. double-hashed) to generate a transaction identifier (TxID) of that transaction. The transaction identifiers are then used as the leaf nodes of the Merkle tree. Pairs of transaction identifiers are then concatenated and hashed to form a respective inner node of a first inner level of the Merkle tree. Pairs of inner nodes of the first inner level are then concatenated and hashed to form a respective inner node of a second inner level of the Merkle tree. The process of concatenating and hashing pairs of inner nodes is repeated until only a single hash remains: the Merkle root. This Merkle root is sometimes referred to as the block Merkle root.

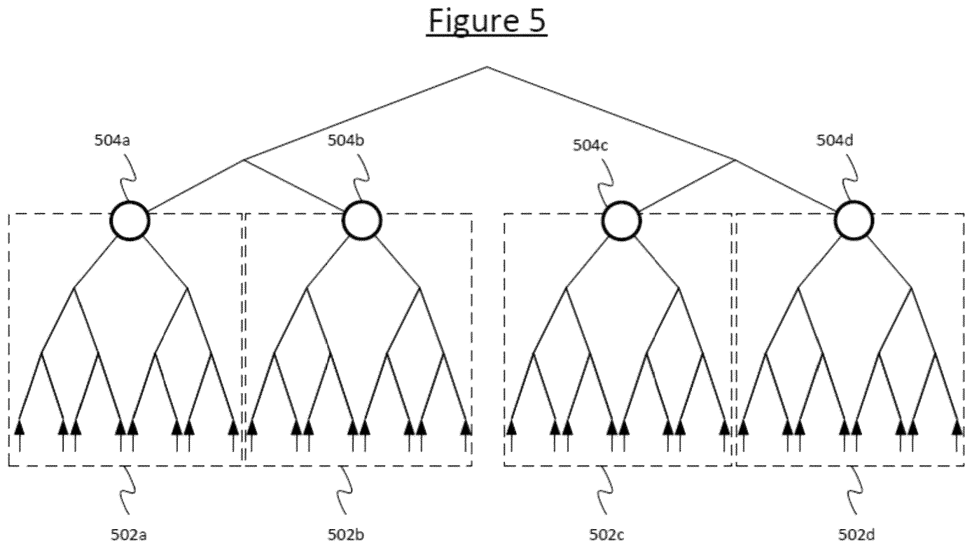

We now turn to embodiments of the disclosure, with reference in particular to FIGS. 5, 6 and 7.

### Identifying Segments of a Block'S Merkle Tree

Suppose that a particular party e.g., Alice wishes to validate some transactions. In accordance with an embodiment of the disclosure, at least one subset of transactions is identified wherein the subset forms and/or is represented by a segment of the overall Merkle tree for the block. Thus, the block of transactions can be logically segmented into a plurality of segments based on the block's Merkle tree, each segment comprising a subset of the block's transactions and each segment having its own root node (or “root hash”). This common root hash is sometimes referred to below as a “segment hash” to distinguish it from the root hash of the entire block.

Transactions on the same level (i.e., the lowest level, sometimes referred to as the “leaf level” or “leaf layer”) within a tree segment are siblings. All transactions in a given segment share a common root node for that segment. The common root node may belong to the adjacent level of the Merkle tree, i.e., the level immediately above the lowest level. Alternatively, the common root node may belong to a higher level. In general, the common root node may belong to any level of the Merkle tree between the lowest level and the Merkle root.

Breaking the block down into smaller parts based on its Merkle tree provides significant technical advantages, including the ability to quickly and efficiently allocate transactions across multiple validators. For example, as certain example blockchain protocols use binary trees it is possible to implement binary allocations across multiple machines. By using a small binary marker as an indexing system for the segments, each segment's position in the overall Merkle tree can be calculated quickly, enabling the segments to be put back together after validation has been completed, reconstructing the complete Merkle tree for the block. This binary indexing approach is discussed in more detail below.

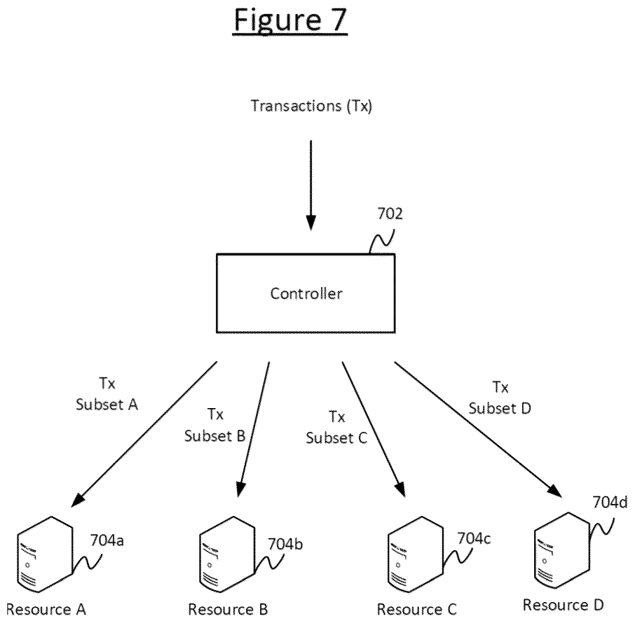

Various techniques can be used for identification of the segments, but in accordance with one approach the number of segments may be determined by the number of available validators in the system. For example, in a system having four validators, the Merkle tree may be split into four segments; if there are eight validators, the Merkle tree may be dissected into eight segments and so forth. Identification of the segments for a given Merkle tree can be performed or influenced by a controlling entity, illustrated by controller 702 of FIG. 7.

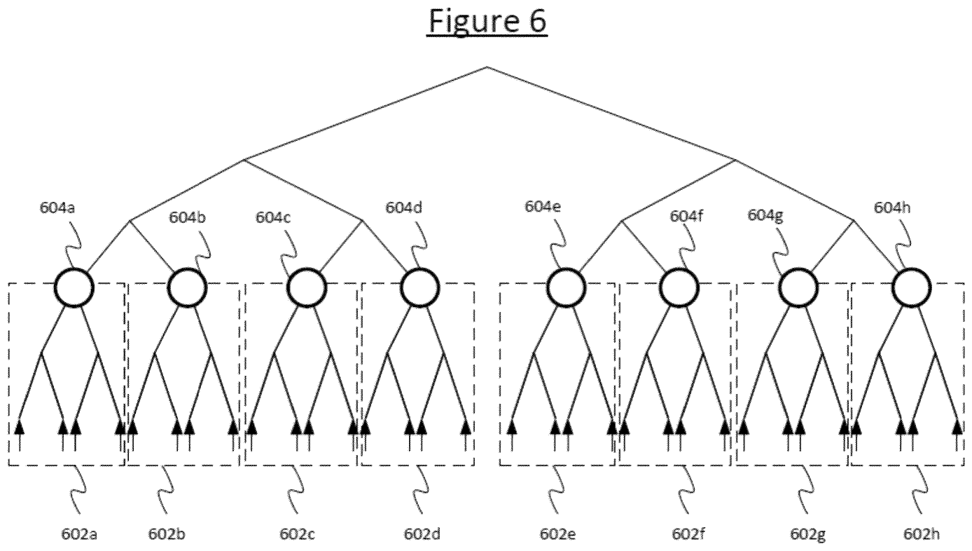

The points explained above are further illustrated with reference to FIGS. 5 and 6, in which FIG. 5 illustrates an example of how a Merkle tree may be divided into separate portions 502 to be allocated to validators. In the example of FIG. 5, each arrow represents a respective transaction that is hashed to form a respective transaction identifier, which is used at a respective leaf node of the Merkle tree. The top of the Merkle tree is the block Merkle root. In this example, the block of transactions represented by the Merkle tree contains 32 transactions. However, it will be appreciated that this is merely an illustrative example and in general the Merkle tree may contain any number of transactions, depending on the number of transactions in the block. As shown, the Merkle tree is divided into four portions 502a-d, indicated by the dashed line boxes. Each portion 502 is linked by a respective common inner node (inner hash) 504 of the Merkle tree, which is indicated by the solid line circles. Each portion 502 represents eight transactions. In this example, the common inner nodes 504 belong to the fourth level of the Merkle tree. According to the embodiments described herein, each respective portion 502 (or rather the transactions that form and/or represent a portion) is allocated to a respective validator for processing, e.g. for validating of the transactions that belong to the respective portion 502.

FIG. 6 illustrates another example of how a Merkle tree may be divided into portions 602. The Merkle tree in FIG. 6 is the same as that of FIG. 5. Now, in this example, the Merkle tree is divided into eight portions 602a-h, with each portion 602 representing four transactions. In this example, the common inner nodes 604 belong to the third level of the Merkle tree. The Merkle tree of FIGS. 5 and 6 could instead be divided into more (e.g. sixteen) or less (e.g. two) portions 502, 602. In general, a Merkle tree formed from a set of transactions of a block may be divided into any number of portions 502, 602, where each portion includes a minimum of two transactions.

### Allocation of Segments to Respective Validation Resources

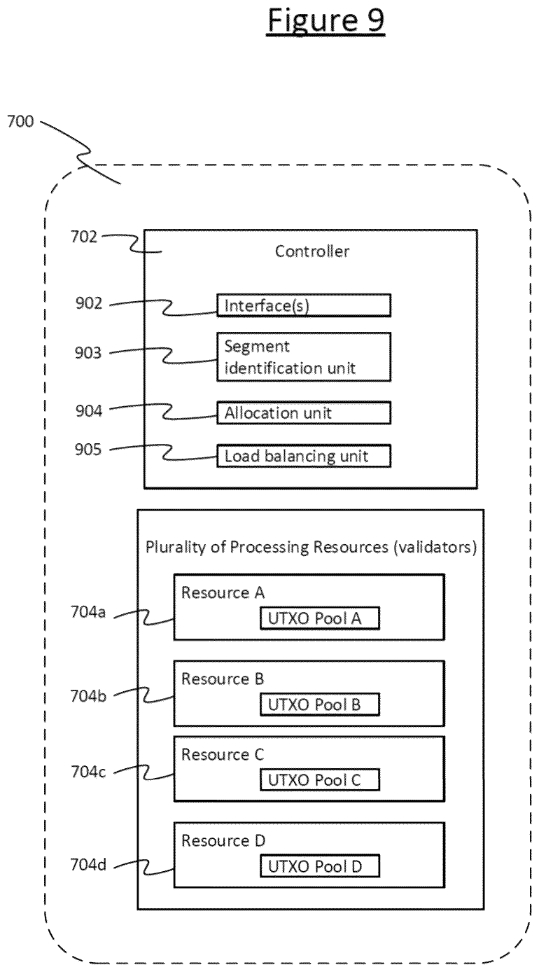

Following their identification, the subsets of transactions are distributed across a plurality of validation resources, which may also be referred to as “validators” for ease of reference. A plurality of validators is shown as resources A to D (704a to 704d) in FIGS. 7 and 9. The allocation process may be directed or influenced by a dedicated unit such as component 904 as shown in FIG. 9, without limitation.

Each validator (704a to 704d) can comprise one or more processing resources. Therefore, at least one of the validators in a plurality of validators (704a to 704d) may be or comprise at least one of the following: one or more virtual machines, one or more servers, one or more GPU-based computing resources, one or more threads and/or one or more multiprocessor systems etc.

Essentially, any of the plurality of validators can be made up of any type(s) or combinations of processing resource, each capable of validating one or more transactions which are associated with each other by a segment of the block's Merkle tree. The plurality of validators (704a to 704d) and other system components form a collective resource or entity 700, which we will refer to as a “(distributed) validation node”.

Preferably, distribution comprises allocating each of the segments to a respective validator within the plurality of validators. The validators may be arranged, at least, to:
operate on the one or more transactions which make up the segment(s) that have been allocated to them,
validate one or more transactions to verify that they conform to the blockchain protocol, and/or
validate that they can be identified in an existing repository such as the blockchain ledger or a database of known, registered or spent transactions.

The validators' activities, and allocation of the subsets to the different validators, may be directed by a controller. FIG. 7 shows controller 702 allocating subsets of transactions A to D for respective tree segments to validators 704a to 704d respectively. The system-level controller 702 coordinates the activities of systems or devices 704a to 704d within the distributed validation node, and may control or influence tasks such as identification of tree segments with the block's Merkle tree, allocation of the identified segments to respective validators, reordering of validated tree segments into a complete Merkle tree for the block, and/or ordering transactions within the reconstructed block.

One or more of the validators may comprise at least one coordinating entity arranged to act as a controller at the validator level. Thus, any or all of validators 704a to 704d may comprise at least one controller component of its own. This lower-level controller may influence or direct operations such as the allocation of tasks or subtasks to one or more processing resources within the validator, reconstruction of the Merkle tree for a given segment, or interaction with other system components e.g. other validators or higher level controllers, UTXO pools, wallets etc. In turn, the processing resources themselves may be further decomposed into smaller systems, one or more of which may comprise a controller and one or more processing resources of its own. In this way, the system may comprise a hierarchical architecture in which segment validation is performed by validating entities comprising one or more processing resources for performing the validation tasks and one or more controllers for coordination of the processors' activities and the execution of inter-component communications.

In embodiments where a validator comprises multiple processing resources, the validator may split its allocated segment into smaller segments. The validator's controller can then distribute the sub-segments across the processors under its control. In this way, the validation process can be implemented in a hierarchical and distributed manner.

This hierarchical decomposition can also be extended to the transaction level so that the validation may be further decomposed into sub-processes or tasks per transaction rather than at the tree segment level. In this approach, the validation of individual transaction(s) is broken down into sub-tasks that are distributed across different machines, or different threads running on the same or different machines. These processes can be queued such that as a thread becomes available, another transaction or task is allocated to it.

Thus, the disclosure enables many transactions to be processed simultaneously, with the only limit being the amount of hardware available to form the distributed validation node rather than the amount of available processing speed being the bottleneck, as per traditional techniques.

This enables blockchain processing systems to scale horizontally without the need to alter the underlying protocol of the blockchain network.

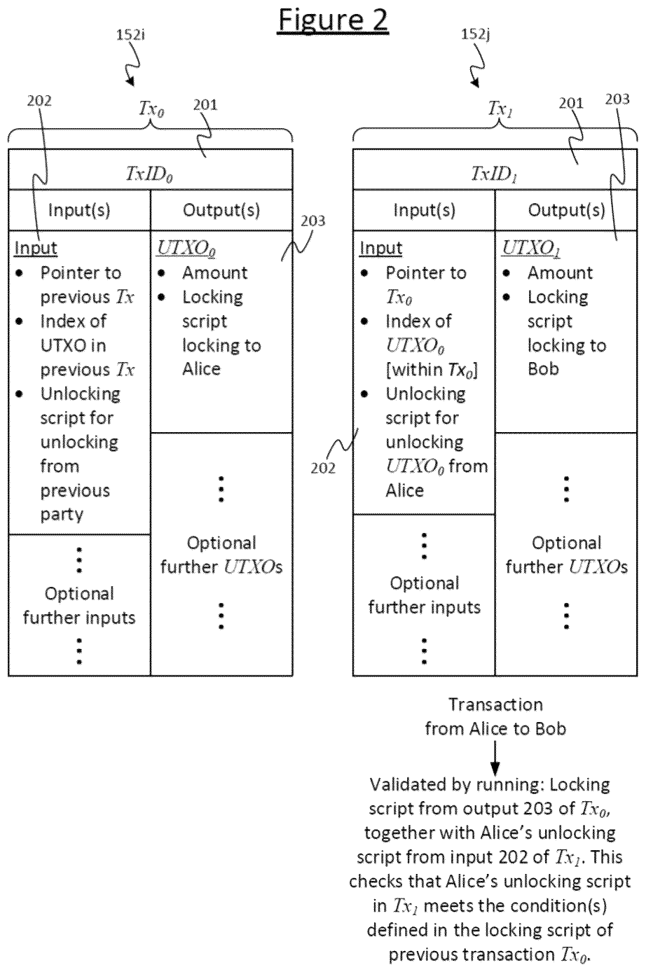

Therefore, the disclosure represents a significant deviation from the traditional approach to validation which is described in more detail ion the section below entitled “Example technical environment for implementation of an illustrative embodiment of the disclosure”, and with reference to FIGS. 1 and 2. As explained, the traditional approach involves one block being validated as an entire entity, and the traditional view of a validation node (see FIG. 1, 104) being a single computing unit. By contrast, embodiments of the disclosure break the Merkle tree into multiple segments which are given to different validators (704a to 704d in FIGS. 7 and 9), each of the segments and validators being capable of being further broken down to enhance the degree of distribution involved.

Further still, by breaking each block down into segments based on its Merkle tree, embodiments of the disclosure enable validators to access, download and process small portions of the block rather than the whole block. Recall that the transactions in each segment hash up (in pairs) to a single root value. This means that the segment can be validated using only the necessary, relevant transactions rather than the entire block being downloaded, stored and processed in entirety. As some blockchain protocols allow for scaling of block size and inclusion of larger blocks in the ledger, the traditional model of downloading a whole block becomes a bottleneck. Embodiments of the disclosure overcome this challenge to blockchain scalability by enabling individual validators to receive and process only the (smaller) parts that are relevant to them. This results in faster overall validation times, an improved blockchain network and improved applications which run on the blockchain.

Further still, embodiments support and facilitate the use of SPV processes and resources, because such SPV involves local validation of only parts of the Merkle tree that are of interest to a given party. The tree-pruning nature of SPV technologies are, therefore, ideally suited for use in combination with embodiments of the present disclosure. In an SPV context, validators may be provided with only the portions of the block data that they need i.e., block header or segment root node and relevant transactions.

When each validator has performed its check and confirmed the validity of the segment that it has processed, it can be guaranteed that the block is valid due to the hashing mechanism that is used to generate the tree.

### Load Balancing Across the Plurality of Validators

Load balancing techniques and systems are known in the art, arranged with the aim of evenly distributing tasks across multiple resources so as to enhance efficiency. The aim is to minimize the risk of some processing resources lying idle while others become overloaded and thus risk degradation of performance or even failure. Therefore, load balancing becomes important in ensuring the resilience of the overall system as well as its performance and efficiency.

Embodiments of the disclosure may utilize any known load balancing technique such as, for example, static or dynamic load balancing. Additionally, or alternatively, the load balancing approach disclosed herein may be used to advantage.

As mentioned above, embodiments of the disclosure can use an indexing system in the allocation of block segments to respective validators. Preferably, this is a binary indexing system. In this preferred system, each validator is designated a binary label or identifier. Suppose that each identifier is 4 digits long, with the first validator being identified as 0000, the next validator being identified as 0001, the next as validator 0010 and so on. Clearly, a 4-digit identifier allows for 256 validator IDs, with the last validator being identified as 1111 (i.e., validator number 255 in decimal).

When a tree segment needs to be assigned to a validator, the first 4 digits of its double hash (i.e., the segment hash of the tree segment) can be used to determine which validator will process that segment. Recall that a Merkle root is generated by hashing together pairs of transaction IDs (TxIDs) from a block to generate respective inner nodes (or inner hashes) of the Merkle tree, and then repeatedly hashing adjacent inner hashes until a single hash is finally arrived at. This double-hashed Merkle root provides an efficient, quick and secure verification mechanism. It also provides the advantage, in the present context, that the double hash generates a random binary number. Each inner hash, including each segment hash, is itself a double hash. Thus, we can take the first x number of leading digits of the segment hash as the allocation index. A hash with four leading zeroes will result in the tree segment being allocated to the validator with ID 0000, and hash with leading digits 0001 will result in allocation to validator with ID 0001 and so on. The random generation of the double hashes ensures a random distribution of tree segments to validators.

Although double-hashing is typically used when generating a Merkle tree, it is not essential in all examples and instead only single-hashing may be used. In fact, any number of hash operations will result in a random binary number. The load balancing tasks may be performed by a dedicated system component, shown as 905 in FIG. 9, or may be provided elsewhere within the system 700, or in association and communication with the system 700.

### Distributed Downloading of Blocks

According to some embodiments, the allocation of segments of the block Merkle tree to different validators may be used to provide a faster and more efficient process for downloading part or all of a block of transactions.

Each validator is allocated a segment of the Merkle tree, e.g., based on the allocation index described above. Any given validator then operates to download the set of transactions that form the allocated tree segment. This may involve downloading the set of transactions from the blockchain itself (e.g., from a blockchain node) or from a different resource or entity, such as a third-party service provider. The set of transactions may be downloaded to internal memory of the validator, or to a shared storage location, such as a shared drive in the cloud.

A distributed node may require the full block, i.e., the entire set of transactions that form the block. In that case, each validator that is assigned a tree segment downloads the subset of transactions that form the segment. In other scenarios, the distributed node may only require certain parts of the block. In that case, only some of the validators may need to download their respective subsets of transactions in order to obtain the desired transactions.

Downloading a block (or part a block) in this fashion results in a faster overall download, as each validator only to process a subset of transactions of the entire set of transactions that form the block. This contrasts with conventional block downloading whereby a given entity (e.g., a full node) would have to download the entire block, e.g., by downloading each transaction in order as it appears in the block. Now, the block is downloaded in parallel by multiple validators. A block may contain tens of thousands of transactions, if not several orders of magnitude more. A single entity downloading this number of transactions would consume significant resources and take a considerable amount of time. The computational burden is now distributed amongst the validators such that each individual validator consumes a fraction of the processing resources. Similarly, the overall time to download the block is reduced.

As discussed, each validator may download a subset of transactions. The subsets may then be combined so as to reconstruct the block in a single storage location. (By “single storage location” we mean either a storage resource which is a self-contained entity or a plurality of associated storage resources which form a collective entity). To do so, the individual validators may transmit their respective subsets to a central controller of the distributed node which is configured to arrange the transactions in the correct order. The segment hash (i.e., the hash that links the tree segment) may be utilized for this purpose. For instance, a mapping may be maintained of the segment hash to its position in the Merkle tree, e.g., from left to right as the segment hash appears in the Merkle tree. The subsets of transaction may then be placed in order (e.g., from first to last as) based on the corresponding segment hash.

In some embodiments, the individual validators (or the distributed node as a whole) may confirm that the correct transactions have been downloaded (or that the transactions have been downloaded correctly) by reconstructing the Merkle tree. After downloading a subset of transactions, a validator may generate a candidate segment hash based on those transactions. The candidate segment hash is constructed by hashing pairs of TxIDs to generate respective inner hashes, and repeatedly hashing pairs of inner hashes until a candidate segment hash is produced. The level of the Merkle tree that the candidate segment hash belongs to will depend on the number of tree segments that the Merkle tree is divided into. The validator may verify that the candidate segment hash is a hash of the Merkle tree. If the hashes do not match, then an error has occurred during download. In some examples, each validator may generate the candidate segment hash and send it to a controller to perform the verification. As another example, a candidate block Merkle root may be generated based on the entire set of downloaded transactions. Again, the candidate Merkle root should match the actual block Merkle root (i.e., the Merkle root stored in the block) if the block has been correctly downloaded.

In some cases, the validators may validate the downloaded transactions using the techniques described above. That is, each validator is allocated a tree segment, downloads the corresponding subset of transactions, and validates those transactions. In other cases, the validators may not necessarily validate the transactions and may simply download the transactions for later use, e.g., for sending to a third party.

### Distributed UTXO Pools

Preferably, each validator 704 that forms part of the distributed validation node has its own repository (pool) for generating, storing and/or maintaining unspent transaction outputs (UTXOS). This functions as a UTXO pool that provides a record of unconsumed i.e. unspent outputs associated with blockchain transactions. Each validator's UTXO pool is, therefore, based on and constructed from the transactions that are allocated to it by the controller in respect of Merkle tree segments. In one embodiment, this may be a (graph) database comprising data relating to the unspent UTXOs of transactions that have been assigned to a given validator for processing. A record in the database is created for each UTXO that the validator becomes aware of as new Merkle tree segments are allocated to it. From the perspective of the distributed validation node, therefore, the UTXO pool is not one single pool but is made up of a plurality of different UTXO pools, each provided at or on different validators and comprising different sets of UTXOs. The UTXO pool for the node is, therefore, distributed in both in terms of the data and also the resources which store and/or process it.

This is a significant divergence from the traditional UTXO model in which each full node in the network has a copy of the UTXO pool that tracks all UTXOs on the blockchain. By contrast, the present disclosure distributes the UTXO pool across a plurality of validating resources, each having a UTXO pool that is a subset of the blockchain's entire UTXO set. Each validator's UTXO pool comprises the UTXOs of transactions which make up the Merkle tree sub-portions that it has been tasked with validating.

In accordance with such an approach, each time a new block needs to be validated it can be implemented in a similar fashion to an SQL transaction log, in that every command, event and item relating to the database is recorded in the log. The term “database log” will be used herein to avoid confusion arising from the use of the term “transaction” as known in relation to blockchains, but we use the term “database log” to include terms such as “transaction journal”, “transaction log” etc. Essentially, the database log can be interpreted as a history of actions executed by a database management system, providing a record of all changes that have occurred in respect of the state of the database, as known in the field of computer-based databases (See en.wikipedia.org/wiki/Transaction_log).

The use of an ordered, historical database log means that the entire UTXO pool can be constructed by executing the log's history in its original order. Advantageously, this ensures that a copy of the database can always be (re)generated when required, and separate copies of the data do not need to be stored. Data integrity is ensured, and fewer storage resources are required. Each UTXO pool can be stored, maintained and processed separately. Also advantageously, SPV techniques facilitate the creation of separate UTXO databases for each validator given that SPV techniques operate on pruned portions of Merkle trees.

Transactions (TXs) within the database can be structured in a variety of ways, although a particularly advantageous approach is to structure them according to identifiers which comprise a concatenation of the block ID and the transaction ID (block_ID II TxID). The block ID and the transaction ID are both 256 bit hashes, resulting in a 512 bit concatenation field structure that is secure and collision free.

Structuring transactions in this way provides a fast, efficient look-up mechanism. Transactions can be sorted by block_ID such that all transactions having the same block_ID are located together in the database. Thus, when a validator requires a transaction (e.g. to check whether a UTXO of the transaction has been spent), the validator can locate the transaction in the database first by searching for the corresponding block_ID, and then the corresponding TxID. This has the effect that the search is confined to the relevant section of the database. This efficiency reduces the time, processing resources and energy required for search operations, providing a significant improvement over prior art

A flag or marker is associated with each UTXO in a validator's pool, and indicates whether the UTXO is locked or unlocked. We may refer to this flag or marker as a “locking flag” for convenience. When a UTXO is marked as “locked”, this serves as an indicator to validators in the group (i.e. elsewhere in the distributed validation node) that this UTXO is not available for spending. Conversely, when a UTXO is marked as “unlocked”, this serves as an indicator to validators that the UTXO can be spent. It functions, therefore, as a way of enabling a validator that has been allocated to verifying a transaction that spends the UTXO to signal to its peers that, assuming the transaction proves to be valid, it has been redeemed and is, therefore, no longer spendable. A “locked” state means that spending is permitted, whereas an “unlocked” state means that spending is prohibited.

This locking/unlocking flag can be a simple, small binary marker such as 0 for “locked” and “1” for unlocked. The marker mechanism is used internally by validators in the distributed node system, the marker is removed from the transaction prior to interacting with the blockchain so that the transaction conforms to the protocol rules.

In use, the validator inspects the outputs in each of the new transactions that have been allocated to it by the controller. Any unspent outputs (UTXOs) are added to the validator's UTXO pool i.e. it is recorded as an entry in the UTXO database. In the relevant database record for each new UTXO, the locking flag is set to “unlocked”.

When the validator sees that a UTXO is being spent by a newly allocated transaction, it sends a message to every other validator in the plurality to inform them that this UTXO should also be locked in their respective pools. Essentially, the validator sends a communication to its peers indicating that it has seen a spend involving a transaction with a particular hash ID at a particular time. The other validators do not need to receive complete data for the entire transaction, as the transaction hash and a list of UTXOs that it spends is sufficient for them to identify the transaction in question and mark it as locked in their own database. Upon receipt of the message, each receiving validator checks whether the UTXO in question is in their UTXO pool. If it is, the state of the locking flag is changed to “locked”. Thus, the lock prevents validators from allowing the same UTXO to be spent in a subsequent transaction. In the event that a new transaction does attempt to spend the same UTXO, a check of the locking flag will indicate that the second spend attempt is to be ignored. If the validator that sent the message determines that validation has failed and therefore the UTXO has not been spent, a further message can be sent out to the validator peers to this effect, indicating that the locking flag for the UTXO should be changed to the “unlocked” state. Once a valid spend has been completed, a message can be sent to this effect, and the locked UTXO can be deleted from the relevant UTXO pool.

In the embodiment described above, each validator has a single UTXO pool which comprises the UTXOs of all the transactions in all of the tree segments that have been allocated to it. However, in an alternative approach, the UTXO pool maintained by each validator may be divided/split/compartmentalised into/formed of multiple sub-pools, one per block. In this way, a single UTXO pool can be organised into a logical hierarchy. In yet another approach, one or more validators may be arranged in association with a respective plurality of UTXO pools, each plurality relating to UTXOs for a set of one or more tree segments. Thus, in some embodiments, validator(s) may organise UTXOs into separate UTXO pools for different individual tree segments, or according to some pre-defined criteria such as type of tree segment, or tree segments which fall within a given range etc. In such embodiments, the identifier may comprise a block ID which can be used to narrow down a search to a relevant UTXO pool, and then the search can proceed within that pool to (attempt to) identify the relevant transaction by its TxID. The skilled person will understand that in some embodiments, a mixture of these approaches can be used i.e. one or more validators within the distributed node may employ the single-UTXO-pool approach while other(s) are arranged to use multiple, separate UTXO pools, and/or UTXO pools which are organised into sub-pools, or any combination thereof.

This provides protection against “double spend” situations, in which a party attempts to spend the same UTXO twice. This provides a simple and secure locking mechanism that operates efficiently and quickly, regardless of the number or location of the validators in the system, and preserves the security and integrity of transfers implemented over the blockchain.

### Illustrative System of a Possible Embodiment

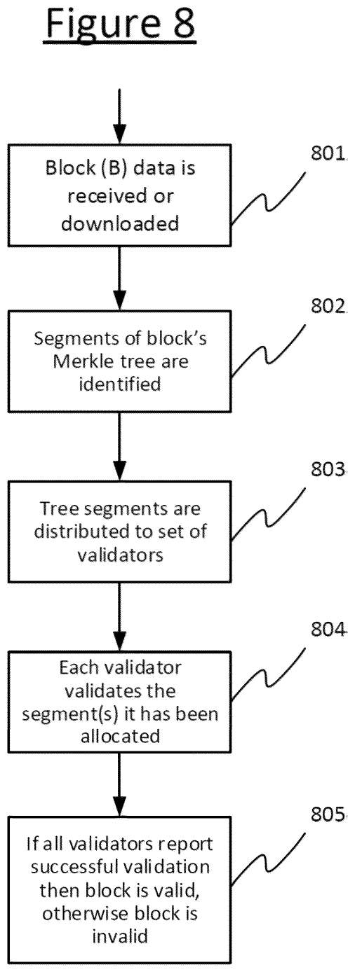

FIGS. 7 and 9 illustrate an example system 700 for implementing at least some of the described embodiments. FIG. 8 illustrates a flowchart of example steps which may be taken in (a high-level view of) a method of the disclosure.

The system 700 may be a closed system in the sense that it may be associated with an organisation and form part of a larger proprietary system. In such cases, its data e.g. transactions, may be received from other components within the organisation's wider system and its results and outputs may be sent to internal destinations. Additionally, or alternatively, system 700 may be arranged to interface with a variety of entities, some or all of which may be located outside the organisation. In such cases, system 700 may be arranged to provide validation functionalities as a service. For example, system 700 may be arranged to interact with the blockchain network to obtain the data that it requires. Additionally, or alternatively, it could interact with entities that wish to use its validation services. Thus, system 700's activities could be solely internal with respect to a particular organisation or entity, or open to interactions with external entities to provide validation services to other parties, or a combination of the two. Communications between other internal or external entities may be coordinated by one or more interface or communication components, shown as 902 in FIG. 9.

As shown in FIGS. 7 and 9, the system 700 includes a controlling entity 702 (or simply, “controller”) and a plurality of validating resources 704, also referred to herein as simply “validators”. Only four validators 701a-d are shown in FIG. 7, but in general the system 700 may comprise any number of validators. Moreover, the controller 702 is shown in FIGS. 7 and 9 as distinct from the validators 704, but it is not excluded that the controller 702 may comprise or be comprised by one of the validators 704. As explained above, each validator may comprise one or more processing resources, and may comprise its own controller for coordination of its own internal activities. There is no technical or logical limit to the hierarchical levels that can be implemented in this way. FIG. 7, however, shows only one (top) level of such a hierarchy for simplicity and ease of understanding.

As shown in FIG. 7, the controller 702 obtains a set of transactions. The transactions can be received across an electronic channel or network from a sending resource. The sender may be any entity which wishes to perform a validation check of some kind, internal or external to the system's organisation as explained above. For example, this could be a full node on a blockchain network such as node 104 in FIG. 1, or a digital wallet, or a merchant/SPV node wishing to perform a local check relating to a blockchain-implemented transfer made between parties. Interface(s) 902 may facilitate the transmission of data between the system 700 and sources external to the system.

The transactions form, or may form, a block of transactions. The transactions may be obtained from a single resource (e.g. from a block of the blockchain) or from different resources (e.g. one or more users, one or more blockchain nodes, etc.). The transactions may be obtained prior to them having been published on the blockchain, i.e. before being recorded in a block. Alternatively, the transactions may be obtained after having recorded on the blockchain.

The controller 702 allocates a respective subset of transactions to each validator 704 as described herein. Each subset of transactions forms at least part of a respective portion of a Merkle tree generated based on the full set of transactions, and is linked by a respective common inner node of the Merkle tree. In the example of FIG. 7, transaction subset A is allocated to validator A, transaction subset B is allocated to validator B, transaction subset C is allocated to validator C, and transaction subset D is allocated to validator D. Having been allocated a subset of transactions, the validators 704 then process their respective subset. In some embodiments, this involves each validator 704 validating its respective subset of transactions. To do so, the controller 702 may transmit the relevant transactions to the respective validators 704. The validators 704 may communicate back to the controller 704 to indicate that each of their respective subset of transactions is valid or that at least one transaction is not valid.

At least one but preferably some or all of the validators 704a to 704d have access to their own UTXO pools shown as 901a to 901d in FIG. 9. This pool comprises a storage facility such as the database described above, and potentially with the advantageous indexing structure comprising a concatenation of the block ID and the transaction ID. In FIG. 9 the pools are shown as included within the respective validator but the skilled person will readily understand that they may also/alternatively be provided as external to the validator but in communication therewith.

In one or more embodiments, the disclosed process may include a block-level validation stage, during which an incoming new block is tested against block-level criteria. Example block-level criteria are described above and generally relate to prescribed formatting requirements and characteristics or limits applicable to the block itself, as opposed to the transactions within the block. Examples include the block size, the block header structure or content, and similar criteria. Such operations may be performed by the controller, or a component of the controller, or by another system component.

In some embodiments, the method may further include a UTXO uniqueness confirmation module which is operative to evaluate whether each of the inputs, i.e. each UTXO, to a transaction in the new block is unique. If the same UTXO appears more than once as an input in the new block, it indicates a potential double-spending problem and violates the UTXO uniqueness criteria. If the UTXO uniqueness confirmation module identifies a UTXO that is referenced more than once among the transaction inputs in the new block, then it may output an error signal or other interrupt to indicate that the block is to be rejected.

Assuming that the new block does not get rejected, i.e. that all the UTXO inputs are unique, then the Merkle tree segments can then be identified and their associated transactions allocated among the set of validators. The identification process may be performed by a component such as segment identification unit 903, shown in FIG. 9. The allocation process may be performed by a segment allocation unit, shown as 904 in FIG. 9. The allocation unit 904 may employ any one of a number of possible allocation schemes for distributing the block segments amongst the individual validators, but in an advantageous approach the allocation scheme may be aimed at load balancing as described above. The allocation unit 904 may comprise (or be in communication with) a load balancing unit 905. Although this is shown as a separate, associated component of the system in FIG. 9, in other embodiments load balancing unit may be part of the allocation unit 904, or may be separate relative to the controller 702. Any combination of components may be readily employed.

The individual validators validate the transactions associated with the segment(s) they receive against transaction-level validation criteria. The validators do not require synchronization paradigms between them as they each work independently on verifying that the transactions that they have been allocated are valid. Each validator outputs a result confirming the validity of its allocated transactions. The results are added or accumulated to confirm that all the transactions in the segment are valid. In the event that one of the validators identifies a non-compliant transaction, i.e. an invalid transaction, then it may issue an output, such as an interrupt or other signal, to indicate that there is an invalid transaction. That interrupt or signal may be sent to the other validators or to the controller or another system component so that they can immediately cease testing their respective transactions and not waste further resources on validating transactions within a block that is to be rejected.

In some examples, the system may be arranged to check block-level criteria. This may be performed prior to allocation of the segments to the validators, although it will be appreciated that the block-level validation stage may occur after the transaction-level validation testing by the validators or, in some instances, in parallel with the transaction-level validation testing.

Reference will now be made to FIG. 8, which shows, in flowchart form, one example of a method of validating a block. The block contains a plurality of transactions, each transaction references one or more inputs, and each input is a UXTO (except in the case of a coinbase generation transaction). The method is implemented using suitable hardware and processor-executable instructions within a node on the blockchain network.

In operation the distributed validation node 700 receives new block data at step S801. This may be an entire block, or in the case of an SPV-related validation, it may comprise only partial data required for performing an SPV check. We will refer to this as data as “the block” for convenience. The new block that is to be validated may be received from a mining node on the blockchain network that generated the new block and completed the proof-of-work, or it may be received from a merchant node that wishes to perform an (SPV) check, or it may be received from a wallet such as an SPV wallet. The new block may be received from another (non-mining) node in the network. In some examples, the distributed validation node 700 validates the block before forwarding it to any other nodes in the network. As discussed above, the validation of the new block may include confirming that the block meets certain protocol-based criteria, and/or other criteria that may be specified and required within a given implementation.

At step S802, the system 700 identifies chunks of the block's Merkle tree. At S803 the segments are distributed to a plurality of validators, and S804 the validators process their respective subsets of transactions substantially in parallel and independently of each other. At S805, the validators signal to the controller whether validation has been successful or has failed.

It should be noted that the term “processors”, when used in connection with the description of parallel processors herein, does not necessarily mean physically distinct microprocessors and may include any hardware or software implementation that enables parallel processing resources capable of carrying out processor functions independently and in parallel. The parallel processors may include one processor having multiple cores. In some instances, the parallel processors may include multiple separate processing units. The parallel processors may or may not share a physical memory. Each parallel processor, howsoever implemented, has a software or hardware mechanism for signalling, such as to output a signal in response to identifying an invalid transaction. The implementation of the parallel processors also includes providing for the requisite data transfer mechanism, in software and/or hardware, to route the allocated transaction data to the respective processors for local processing.

### Clause Set 1

Any embodiment defined in any clause or combination of clauses in clause set 1 may be arranged to implement or combine with any other clauses or examples herein.

Clause 1.1. A computer-implemented method, the method comprising: processing a tree structure that represents an item and/or at least one component of the item; and associating the item and/or the at least one component of the item with a blockchain transaction (Tx), which is represented in the tree structure.

Processing can comprise at least one of generating, storing, accessing and maintaining the tree structure. The tree structure can be a hash tree. The tree structure can be asymmetric, such as an ontology tree.

At least part of the tree structure can be processed. This can validate an item or component is part of the tree structure. The at least part can include a path between the root and the node representing the item or component.

Clause 1.2. The method of clause 1.1, wherein the method further comprises processing a record of the item and/or the at least one component of the item, and at least one of: validating that at least one of: the item, the at least one component of the item and the at least a portion of a blockchain transaction (Tx) is a part of the tree structure; and processing and/or storing at least one of: the item, the at least one component of the item and the at least a portion of a blockchain transaction (Tx) in an allocated resource (1104).

The record can be data associated with the blockchain transaction. The record can comprise a proof that at least one of the item, component and blockchain transaction are part of the tree structure.

The at least a portion of the blockchain transaction can be an output of the transaction. The output of the transaction can be an unspent transaction output (UTXO) and/or a transaction (Tx) containing a UTXO of a blockchain block. The record can be stored in a database e.g. an allocated resource, said record comprising: i) a blockchain transaction comprising at least one data item (D); and ii) at least one further blockchain transaction (TX1) necessary for confirming that the blockchain transaction (TX1) is included in the tree structure.

Data associated with the item or component e.g. the data item (D) can be stored in association with a script in the transaction. Additionally or alternatively; and/or the data item (D) can be stored as metadata within the transaction.

The record can comprise validation data required to validate the blockchain transaction e.g. unspent transaction output (UTXO) is associated with the tree structure. The record can further comprise a history of a plurality of preceding blockchain transactions.

Clause 1.3. The method of clause 1.1 or 1.2, wherein each item and component of the item are represented by nodes and leaves in the tree structure, and hashed to create a hash tree.

Clause 1.4. The method of clause 1.3, wherein a hash of the root node of the tree structure is stored in the blockchain transaction (Tx) on the blockchain ledger.

Clause 1.5. The method of any preceding clause, wherein at least a portion of the tree structure is stored on a blockchain ledger.

The blockchain ledger can be a private ledger stored on a server. At least the hash of the root node can be stored on a public blockchain.

Clause 1.6. The method of any preceding clause, further comprising: processing a second tree structure that represents the item and/or the at least one component of the item; associating the item and/or the at least one component of the item with a second blockchain transaction (Tx), which is represented in the second tree structure; and associating the blockchain transaction in the tree structure with the second tree structure.

The second tree structure can be in iteration of a first tree structure e.g. wherein a node of a first tree structure is updated. Additionally or alternatively, the second tree structure can be independent of the first tree structure e.g. wherein a node of a first tree structure is updated and the updated node is represented in the second tree structure.

Clause 1.7. The method of clause 1.6, further comprising processing the record to validate that at least one of: the item, the at least one component of the item and the at least a portion of a blockchain transaction (Tx) is a part of the tree structure or the second tree structure.

Clause 1.8. The method of any preceding clause, wherein the blockchain transaction includes at least one of: a history of the or each tree structure from which the blockchain transaction originated; and a history of the allocated resources in which the blockchain transaction was stored, wherein said history enables validation that at least one of: the item, the at least one component of the item and the at least a portion of a blockchain transaction (Tx) is a part of the tree structure or the second tree structure.

Clause 1.9. The method of any preceding clause, wherein the blockchain transaction (Tx) is used to identify and/or allocate the allocated resource.

Data associated with at least one of the item, component and tree structure or the associated blockchain transaction, or a portion thereof, can be used to identify and/or allocate a processing and/or storage resource. The data can comprise, at least in part, an unspent transaction output (UTXO) and/or a transaction (Tx) containing a UTXO.

Clause 1.10. The method of clause 1.9, further comprising storing and/or processing at least a portion of the blockchain transaction (Tx): in the allocated resource; and/or by the allocated resource; and/or in association with the allocated resource.

Clause 1.11. The method of any of clauses 1.2 to 1.10, wherein the blockchain transaction, or hash thereof, is used to determine a key, wherein the key determines the allocated resource.

Clause 1.12. The method of clause 1.11, wherein the key comprises at least one of: an alphanumeric number; and a binary number, and said number is used to determine the allocated resource.

Clause 1.13. The method of clause 1.11 or 1.12, wherein the blockchain transaction, or hash thereof, or key is parsed to determine the allocated resource.

Clause 1.14. The method of any preceding clause, wherein the blockchain transaction comprises at least one of: a Merkle Tree of the block in which said transaction (Tx) is recorded; the Merkle root the block in which said transaction (Tx) is recorded; a Merkle path, which enables the determination of the value for the Merkle root for the block in which said transaction (Tx) is recorded, from a hash of said blockchain transaction (Tx); a Merkle proof; a block identifier (block_ID) associated with the blockchain block a transaction identifier (TxID) associated with a transaction (Tx) in the plurality of blockchain transactions within the blockchain block; a function of the block identifier (block_ID) and the transaction identifier (TxID); and a concatenation of the block identifier (block_ID) and the transaction identifier (TxID).

Clause 1.15. The method of any preceding clause, further comprising, for at least a portion of the blockchain transaction (Tx), at least one of: validating and/or verifying said blockchain transaction (Tx); performing at least part of a Simplified Payment Verification (SPV) process for said blockchain transaction; confirming whether the blockchain transaction (Tx) is contained within the blockchain block; determining a Merkle proof for said blockchain transaction (Tx); and a proof that the associated blockchain transaction is part of the tree structure, by at least one of using a hash of the root of the tree structure and a path that enables the determination of the hash of the root for the tree structure in which said associated blockchain transaction is recorded, from a hash of said blockchain transaction.

Clause 1.16. Computer equipment comprising: memory comprising one or more memory units; and processing apparatus comprising one or more processing units, wherein the memory stores code arranged to run on the processing apparatus, the code being configured so as when on the processing apparatus to perform the method of any of clauses 1 to 16.

Clause 1.17. A computer program embodied on computer-readable storage and configured so as, when run on one or more processors, to perform the method of any of clauses 1.1 to 1.16.

### Clause Set 2

Any embodiment defined in any clause or combination of clauses in clause set 2 may be arranged to implement or combine with any other clauses or examples herein.

Clause 2.1. A computer-implemented method, the method comprising: associating data with a blockchain transaction (Tx), wherein said data is represented in a tree structure, processing a path of the tree structure that includes the data; processing a digital signature of an author and/or approver of said data; and validating that at least one of: the data, the digital signature and the blockchain transaction (Tx) is a part of the tree structure.

The method can be performed by a machine e.g. a computer operating a browser for accessing a web page via a web address. Through the association with the blockchain transaction, and processing the tree structure and a digital signature associated with the data e.g. a web page, or content thereof, the validity of the data can be determined, and the browser can selectively access only valid data.

The tree structure can be a hash tree. Simplified Payment Verification techniques can be used to determine that data is part of the tree structure. At least one of the data, the digital signature and the blockchain transaction (Tx) can be hashed when associated with the tree structure.

Therefore, not only does validation consider whether data is included in the tree structure it can also validate signatures associated with said data. This can enable validating data, or any part thereof e.g. a web page, and content of that web page, but the provenance of the creator or authority of the data can be validated. Validation can include a digital signature of at least one of the creator, the authority and the associated blockchain transaction. A web address is just one example of a set of data that can be represented as a tree structure.

Clause 2.2. The method of clause 2.1, wherein the digital signature is associated with the blockchain transaction.

Clause 2.3. The method of clause 2.1 or 2.2, wherein the data and the digital signature are combined.

The data and digital signature can be concatenated. A hash of the data and digital signature can be concatenated. Overall, the digital signal is associated with the data to be validated.

Clause 2.4. The method of any preceding clause, wherein validating comprises determining that the digital signature is a part of the tree structure.

Clause 2.5. The method of any preceding clause, further comprising processing and/or storing at least one of: the data, the digital signature, the tree structure item and the blockchain transaction (Tx) in an allocated resource (1104).

Clause 2.6. A computer-implemented method, the method comprising: processing data to produce processed data and associating said data and/or said processed data with a digital signature of an author and/or approver; representing said data and/or the processed data in a tree structure; associating at least one of the data, the processed data and/or the digital signature with a blockchain transaction (Tx), which is represented in the tree structure; and recording of at least one of the data, processed data, the digital signature, the blockchain transaction (Tx) and the tree structure on a blockchain.

Processed data can be data that has been associated or otherwise combined with a digital signature. For example, data to be validated can be concatenated with a digital signature. Prior to association the data and/or the digital signature can be processed e.g. hashed.

This method processes data that is to be subsequently validated. It can be performed by a machine to retrieve and/or receive data and digital signatures for creating a tree structure. In one example a web address is processed with the digital signatures of its creators and/or authority. Digital signatures can also be retrieve and/or receive for components of the data e.g. components of a web page as part of a web address. A hash tree can be established.

Clause 2.7. The method of clause 2.6, further comprising processing an update to the data to produce updated processed data, and representing the updated processed data in a second tree structure.

The second tree structure can be an iterative update of the first tree structure. Second tree structures, and subsequently created tree structures can be used for tracking data. Tree structures schematically representing different versions of the relationship between data and the rest of the tree structure. The second tree structure can be used to determine the validation and/or provenance of an item and/or component from the point at which it was first tracked using a tree structure. Tracking can take place using one tree structure, or a plurality of tree structures. Each tree structure can represent an alternative relationship of the item and/or component with different items and/or different components. Tree structures can be independent, and a plurality of tree structures can be used to track an item and/or the at least one component of the item with a blockchain transaction (Tx) that migrates. The tree structure can be a Merkle tree, Binary tree, ancestor tree, asymmetric tree or otherwise unbalanced.

Clause 2.8. The method of clause 2.6 or 2.7, wherein the processed data is stored in a node of the tree structure or the second tree structure, and wherein each node of the tree structure or the second tree structure comprises at least one of data, processed data and/or the digital signature with a blockchain transaction (Tx), which is represented in the tree structure.

Clause 2.9. The method of any of clauses 2.6 to 2.8, further comprising processing at least one of the data, the processed data, the digital signature, the blockchain transaction (Tx) and the tree structure to produce a hash thereof, and storing said hash on the blockchain.

Clause 2.10. The method of any of clauses 2.6 to 2.9, further comprising processing and/or storing at least one of: the data, the processed data, the digital signature, the tree structure and the blockchain transaction (Tx) in an allocated resource (1104).

Clause 2.11. The method of any preceding clause, wherein the data is represented by a node or a leaf in the tree structure, and hashed to create a hash tree.

Clause 2.12. The method of clause 2.11, wherein a hash of the root node of the tree structure is stored in the blockchain transaction (Tx) on the blockchain ledger.

Clause 2.13. The method of any preceding clause, wherein the tree structure represents a web address and the data is content on a web page of the web address and accessible via a path of the web address, said path providing a link to content, and wherein the tree structure comprises at least one of: a top-level domain; a second-level domain; a subdomain; and a subdirectory.

The content can include at least one of: HTML data, links, executable files, certificates, documents, multimedia data and machine-readable data.

Clause 2.14. The method of clause 2.13, wherein the content of each web page is signed by a digital signature of an author and/or approver of said data.

Clause 2.15. The method of any preceding clause, wherein the blockchain transaction includes at least one of: a history of the or each tree structure from which the blockchain transaction originated; and a history of the allocated resources in which the blockchain transaction was stored, wherein said history enables validation of at least one of: the data, processed data, the digital signature, the blockchain transaction (Tx) and the tree structure on a blockchain.

Clause 2.16. The method of any of clauses 2.5 to 2.15, wherein the blockchain transaction (Tx) is used to identify and/or allocate the allocated resource, and preferably wherein a hash of the blockchain transaction is used to determine a key, wherein the key determines the allocated resource.

The key can comprise at least one of: an alphanumeric number; and a binary number, and said number is used to determine the allocated resource. At least one of: the data, the digital signature the blockchain transaction (Tx), the web-address, web page, or hash thereof, can be parsed to determine a key and/or the allocated resource.

Clause 2.17. The method of any preceding clause, wherein the blockchain transaction comprises at least one of: a Merkle Tree of the block in which said transaction (Tx) is recorded; the Merkle root the block in which said transaction (Tx) is recorded; a Merkle path, which enables the determination of the value for the Merkle root for the block in which said transaction (Tx) is recorded, from a hash of said blockchain transaction (Tx); a Merkle proof; a block identifier (block_ID) associated with the blockchain block a transaction identifier (TxID) associated with a transaction (Tx) in the plurality of blockchain transactions within the blockchain block; a function of the block identifier (block_ID) and the transaction identifier (TxID); and a concatenation of the block identifier (block_ID) and the transaction identifier (TxID).

Clause 2.18. The method of any preceding clause, further comprising, for at least a portion of the blockchain transaction (Tx), at least one of: validating and/or verifying said blockchain transaction (Tx); performing at least part of a Simplified Payment Verification (SPV) process for said blockchain transaction; confirming whether the blockchain transaction (Tx) is contained within the blockchain block; determining a Merkle proof for said blockchain transaction (Tx); and a proof that the associated blockchain transaction is part of the tree structure, by at least one of using a hash of the root of the tree structure and a path that enables the determination of the hash of the root for the tree structure in which said associated blockchain transaction is recorded, from a hash of said blockchain transaction.

Clause 2.19. Computer equipment comprising: memory comprising one or more memory units; and processing apparatus comprising one or more processing units, wherein the memory stores code arranged to run on the processing apparatus, the code being configured so as when on the processing apparatus to perform the method of any of clauses 2.1 to 2.18.

Clause 2.20. A computer program embodied on computer-readable storage and configured so as, when run on one or more processors, to perform the method of any of clauses 2.1 to 2.18.

### Example Technical Environment for Implementation of an Illustrative Embodiment of the Disclosure

We now describe an overview of a computing environment in which one or more embodiments of the disclosure may be put into practice. However, as noted above, this context is not intended to be limiting and embodiments may be put into effect for the processing of data records and structures that are not implemented via a blockchain. Non-blockchain embodiments may be devised e.g. using a database instead of a distributed ledger.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to some example blockchain protocols a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (also known as scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (also known as scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### CONCLUSION

Other variants or use cases of the disclosed techniques may become apparent to the person skilled in the art once given the disclosure herein. The scope of the disclosure is not limited by the described embodiments but only by the accompanying claims. For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In one or more possible embodiments of the disclosure, the blockchain network 106 could be the bitcoin network and bitcoin nodes 104 could perform at least some or all of the described functions of creating, publishing, propagating and storing blocks 151 of the blockchain 150. However, there may be other network entities (or network elements) that only perform one or some but not all of these functions. That is, a network entity may perform the function of propagating and/or storing blocks without creating and publishing blocks.

In other embodiments of the disclosure, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

The term “user” may be used herein to include human and machine-based entities.

The above-mentioned embodiments illustrate rather than limit the disclosure, and those skilled in the art will be capable of designing many alternative embodiments without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

Any reference in this specification and accompanying Figures to “Bitcoin”, “cryptocurrency” or a particular cryptocurrency protocol may be replaced with the term “blockchain” or “blockchain network”. “token”, “digital asset” or “blockchain protocol” as appropriate to the specific context where these terms are used.

### DISCLAIMER

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A computer-implemented method, the method comprising:
associating data with a blockchain transaction (Tx), wherein said data is represented in a tree structure,
processing a path of the tree structure that includes the data;
processing a digital signature of an author and/or approver of said data; and
validating that at least one of: the data, the digital signature and the blockchain transaction (Tx) is a part of the tree structure.

2. The method of claim 1, wherein the digital signature is associated with the blockchain transaction.

3. The method of claim 1, wherein the data and the digital signature are combined.

4. The method of claim 1, wherein validating comprises determining that the digital signature is a part of the tree structure.

5. The method of claim 1, further comprising processing and/or storing at least one of: the data, the digital signature, the tree structure and the blockchain transaction (Tx) in an allocated resource.

6. A computer-implemented method, the method comprising:
processing data to produce processed data and associating said data and/or said processed data with a digital signature of an author and/or approver;
representing said data and/or the processed data in a tree structure;
associating at least one of the data, the processed data and/or the digital signature with a blockchain transaction (Tx), which is represented in the tree structure; and
recording of at least one of the data, processed data, the digital signature, the blockchain transaction (Tx) and the tree structure on a blockchain.

7. The method of claim 6, further comprising processing an update to the data to produce updated processed data, and representing the updated processed data in a second tree structure.

8. The method of claim 6, wherein
the processed data is stored in a node of the tree structure or the second tree structure, and wherein each node of the tree structure or the second tree structure comprises at least one of data, processed data and/or the digital signature with a blockchain transaction (Tx), which is represented in the tree structure.

9. The method of claim 6, further comprising
processing at least one of the data, the processed data, the digital signature, the blockchain transaction (Tx) and the tree structure to produce a hash thereof, and storing said hash on the blockchain.

10. The method of claim 6, further comprising
processing and/or storing at least one of: the data, the processed data, the digital signature, the tree structure and the blockchain transaction (Tx) in an allocated resource.

11. The method of claim 1, wherein the data is represented by a node or a leaf in the tree structure, and hashed to create a hash tree.

12. The method of claim 11, wherein a hash of a root node of the tree structure is stored in the blockchain transaction (Tx) on the blockchain.

13. The method of claim 1,
wherein the tree structure represents a web address and the data is content on a web page of the web address and accessible via a path of the web address, said path providing a link to content, and
wherein the tree structure comprises at least one of: a top-level domain; a second-level domain; a subdomain; and a subdirectory.

14. The method of claim 13, wherein the content of each web page is signed by a digital signature of an author and/or approver of said data.

15. The method of claim 1, wherein the blockchain transaction includes at least one of:
a history of the or each tree structure from which the blockchain transaction originated; and
a history of the allocated resources in which the blockchain transaction was stored,
wherein said history enables validation of at least one of: the data, processed data, the digital signature, the blockchain transaction (Tx) and the tree structure on a blockchain.

16. The method of claim 5, wherein the blockchain transaction (Tx) is used to identify and/or allocate the allocated resource.

17. The method of claim 1, wherein the blockchain transaction comprises at least one of:
a Merkle Tree of the block in which said transaction (Tx) is recorded;
the Merkle root the block in which said transaction (Tx) is recorded;
a Merkle path, which enables the determination of the value for the Merkle root for the block in which said transaction (Tx) is recorded, from a hash of said blockchain transaction (Tx);
a Merkle proof;
a block identifier (block ID) associated with the blockchain block a transaction identifier (TxID) associated with a transaction (Tx) in the plurality of blockchain transactions within the blockchain block;
a function of the block identifier (block ID) and the transaction identifier (TxID); and
a concatenation of the block identifier (block_ID) and the transaction identifier (TxID).

18. The method of any preceding claim 1, further comprising, for at least a portion of the blockchain transaction (Tx), at least one of:
validating and/or verifying said blockchain transaction (Tx);
performing at least part of a Simplified Payment Verification (SPV) process for said blockchain transaction;
confirming whether the blockchain transaction (Tx) is contained within the blockchain block;
determining a Merkle proof for said blockchain transaction (Tx); and
a proof that the associated blockchain transaction is part of the tree structure, by at least one of using a hash of the root of the tree structure and a path that enables the determination of the hash of the root for the tree structure in which said associated blockchain transaction is recorded, from a hash of said blockchain transaction.

19. (canceled)

20. A computer program embodied on non-transitory computer-readable storage media and configured so as, when run on one or more processors, the one or more processors perform a method of:
associating data with a blockchain transaction (Tx), wherein said data is represented in a tree structure,
processing a path of the tree structure that includes the data;
processing a digital signature of an author and/or approver of said data; and
validating that at least one of: the data, the digital signature and the blockchain transaction (Tx) is a part of the tree structure.

21. The method of claim 16, wherein a hash of the blockchain transaction is used to determine a key, wherein the key determines the allocated resource.
